(19) United States
(12) Patent Application Publication
(10) Pub. No.: US 2026/0093336 A1
(43) Pub. Date: Apr. 2, 2026

(54) CACHING AND REFERENCING STRATEGIES FOR INTERACTION WITH INFORMATIONAL CONTENT IN A PHYSICAL ENVIRONMENT

(71) Applicant: Apple Inc., Cupertino, CA (US)

(72) Inventor: Ashwin K. VIJAY, Sunnyvale, CA (US)

(21) Appl. No.: 19/330,570

(22) Filed: Sep. 16, 2025

Related U.S. Application Data
(60) Provisional application No. 63/700,668, filed on Sep. 28, 2024.

(51) Int. Cl. G06F 3/01; G06F 16/2455

(52) U.S. Cl. CPC G06F 3/017; G06F 16/24552

(57) ABSTRACT

Some examples of the disclosure are directed to systems and methods for capturing and caching one or more first optical captures of an object in a physical environment, and subsequently capturing one or more second optical captures after one or more portions of a user are detected to be directed to the first object. When the one or more portions of the user are determined to satisfy certain criteria (e.g., occluding a first region of the first object), the electronic device performs one or more operations on the one or more first optical captures including recognizing, generating representations of, displaying related information, and/or saving informational content associated with the first object, including informational content occluded by the one or more portions of a user.

### CROSS REFERENCE TO RELATED APPLICATIONS

This application claims the benefit of U.S. Provisional Application No. 63/700,668, filed September 28, 2024, the content of which is herein incorporated by reference in its entirety for all purposes.

### FIELD OF THE DISCLOSURE

The present disclosure generally relates to systems and methods for caching and referencing strategies for interaction with informational content.

### BACKGROUND OF THE DISCLOSURE

Some computer graphical environments provide two-dimensional and/or three-dimensional environments where at least some objects presented for a user's viewing are virtual and generated by a computer. In some examples, a physical environment including one or more physical objects is presented, optionally along with one or more virtual objects, in a three-dimensional environment.

### SUMMARY OF THE DISCLOSURE

Some examples of the disclosure are directed to systems and methods for the interaction of an electronic device with the physical environment. In some examples, the electronic device presents relevant information related to the information identified and detected in the physical environment. In some examples, the interaction includes an input gesture that is detected in connection with an object in the physical environment. For example, the input gesture optionally corresponds to an object-interaction gesture including a pointing gesture directed at an object. For example, the object-interaction gesture optionally includes a pointing gesture by a finger (e.g., an extended index finger, or optionally another finger) of a hand of the user (optionally also with the remaining fingers in a fist) pointing at object. In some examples, the object-interaction gesture includes touching the object or being within a threshold distance of the object. In some examples, performing the object-interaction gesture includes maintaining the pointing gesture (e.g., optionally with less than a threshold amount of movement, and/or optionally with gaze directed at the object or the hand) for a threshold amount of time. Although a pointing gesture is primarily shown and described herein, it is understood that the object-interaction gesture described herein is not so limited. In some examples, the electronic device is a head worn electronic device.

In some examples, the present disclosure provides caching strategies through the implementation of one or more processes on views of the physical environment viewed by a user at an electronic device. After caching, the cached information can be referenced for improved performance. Caching and referencing information enable faster response to user inputs requesting information compared with processing the user input to initiate a request for information from another electronic device (e.g., via a server or network). Additionally or alternatively, the provided methods of caching and referencing information from views of the physical environment reduce the number of inputs required by a user to interact with the physical environment and/or with the electronic device. For example, when a user provides an input to the electronic device to perform one or more operations on informational content, and a portion of the user (e.g., an extended finger) occludes a portion of the informational content while performing an object-interaction gesture, the user does not need to provide secondary input to allow the electronic device to recognize and process the occluded informational content to respond to the object-interaction gesture. Additionally or alternatively, the user does not need to take physical actions (e.g., consulting physical books, dictionaries, encyclopedias, manuals, etc.) to perform contextual searching on informational content or copy informational content. Additionally or alternatively, the user does not need to take further actions (e.g., button presses, touch inputs, verbal commands to a natural language digital assistant, etc.) to instruct the electronic device to recognize, process, and/or perform operations on informational content designated by the user within the field of view of the electronic device. Additionally or alternatively, the initiation of one or more processes through predetermined gestures results in a more intuitive, input efficient, and streamlined experience for a user. Additionally or alternatively, the methods described herein reduce the processor tasking and power consumption of the electronic device using caching compared with referencing the information from other sources or requiring additional inputs to prevent or resolve occlusion.

In some examples, a method is performed at an electronic device in communication with one or more displays and/or one or more optical sensors. In some examples, the electronic device captures, via one or more optical sensors, one or more first optical captures of a first object in a physical environment. In some examples, at least a portion of the one or more first optical captures are cached for reference (e.g., in a memory, buffer, etc.). In some examples, in accordance with detecting, in the one or more first optical captures one or more portions of a user directed to the first object that satisfy one or more first criteria (e.g., object-interaction gesture, or a portion thereof), the electronic device captures one or more second optical captures of the first object. In some examples, in response to capturing the one or more second optical captures of the first object, in accordance with a determination that the one or more portions of the user (or any other object) occlude a first region of the first object from a viewpoint of the electronic device (e.g., as reflected by the one or more second optical captures), the electronic device initiates one or more first operations (Optical Character Recognition (OCR), non-character recognition) on the one or more first optical captures of the first region of the first object.

In some examples, an electronic device in communication with one or more displays and/or one or more optical sensors captures a plurality of optical captures. The optical captures include at least a first object in a physical environment. In some examples, at least a first portion of the plurality of optical captures are cached for reference. In some examples, in accordance with a determination that one or more criteria are satisfied, the one or more criteria including a criterion that is satisfied when an object-interaction gesture directed to the first object is detected and a criterion that is satisfied when at least a portion of the first object is occluded (e.g., by a portion of the user, and/or by one or more other objects) in a second portion of the plurality of optical captures, the electronic device obtains the cached first portion of the plurality of optical captures including a non-occluded view of at least the potion of the object that was occluded in the second portion of the plurality of optical captures. The non-occluded view can be used for processing in accordance with the object-interaction gesture (e.g., performing Optical Character Recognition (OCR), non-character recognition, etc.).

In some examples, one or more first optical captures serve as a cached visual reference of the physical environment. For example, an electronic device in communication with one or more displays and/or one or more optical sensors, optionally captures, via the one or more optical sensors, one or more first optical captures of a first object in a physical environment. Additionally or alternatively, optical captures by another device or representations based thereon can be obtained by the electronic device. The electronic device can process these one or more first optical captures or send the optical captures to another device for processing. The processing optionally includes predicting one or more interactions with the one or more objects in the physical environment and/or one or more virtual objects presented via the electronic device. Additionally or alternatively, the processing optionally includes object recognition and/or scene understanding, which are optionally used to predicting the one or more interactions with the one or more first objects in the first physical environment. For example, the one or more interactions can correspond to a request for informational content corresponding to one or more of the objects. To improve performance (e.g., faster query speed and/or display of informational content), the electronic device optionally stores, in cache or other memory, the informational content corresponding to the predicted interactions/objects. After storing the informational content corresponding to the objects and/or the three-dimensional environment, the electronic device receives input corresponding to an interaction with an object and/or with the three-dimensional environment. In response to receiving the input, and in accordance with a determination that one or more first criteria are satisfied, the electronic device obtains and presents the relevant informational content corresponding to the interaction with an object from the cache or other memory. In some examples, the input and the satisfaction of the one or more first criteria correspond to an object-interaction gesture or a command (e.g., a verbal command to a natural language digital assistant).

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting a three-dimensional environment according to some examples of the disclosure.

FIGS. 2A-2B illustrate block diagrams of example architectures for electronic devices according to some examples of the disclosure.

FIGS. 3A-3K illustrate various examples of an electronic device and user interactions with the electronic device, referencing stored optical captures when occlusion is detected, according to some examples of the disclosure.

FIGS. 4A-4B illustrate flow diagrams for example processes for an electronic device interacting with the physical environment according to some examples of the disclosure.

FIG. 5 illustrates an electronic device presenting a three-dimensional environment according to some examples of the disclosure.

FIG. 6 illustrates a flow diagram for an example process for an electronic device interacting with the physical environment according to some examples of the disclosure.

### DETAILED DESCRIPTION

Some examples of the disclosure are directed to systems and methods for the interaction of an electronic device with the physical environment. In some examples, the electronic device presents relevant information related to the information identified and detected in the physical environment. In some examples, the interaction includes an input gesture that is detected in connection with an object in the physical environment. For example, the input gesture optionally corresponds to an object-interaction gesture including a pointing gesture directed at an object. For example, the object-interaction gesture optionally includes a pointing gesture by a finger (e.g., an index finger, or optionally another finger) of a hand of the user (optionally also with the remaining fingers in a fist) pointing at object. In some examples, the object-interaction gesture includes touching the object or being within a threshold distance of the object. In some examples, performing the object-interaction gesture includes maintaining the pointing gesture (e.g., optionally with less than a threshold amount of movement, and/or optionally with gaze directed at the object or the hand) for a threshold amount of time. Although a pointing gesture is primarily shown and described herein, it is understood that the object-interaction gesture described herein is not so limited. In some examples, the electronic device is a head worn electronic device.

In some examples, the present disclosure provides caching strategies through the implementation of one or more processes on views of the physical environment viewed by a user at an electronic device. After caching, the cached information can be referenced for improved performance. Caching and referencing information enable faster response to user inputs requesting information compared with processing the user input to initiate a request for information from another electronic device (e.g., via a server or network). Additionally or alternatively, the provided methods of caching and referencing information from views of the physical environment reduce the number of inputs required by a user to interact with the physical environment and/or with the electronic device. For example, when a user provides an input to the electronic device to perform one or more operations on informational content, and a portion of the user (e.g., an extended finger) occludes a portion of the informational content while performing an object-interaction gesture, the user does not need to provide secondary input to allow the electronic device to recognize and process the occluded informational content to respond to the object-interaction gesture. Additionally or alternatively, the user does not need to take physical actions (e.g., consulting physical books, dictionaries, encyclopedias, manuals, etc.) to perform contextual searching on informational content or copy informational content. Additionally or alternatively, the user does not need to take further actions (e.g., button presses, touch inputs, verbal commands to a natural language digital assistant, etc.) to instruct the electronic device to recognize, process, and/or perform operations on informational content designated by the user within the field of view of the electronic device. Additionally or alternatively, the initiation of one or more processes through predetermined gestures results in a more intuitive, input efficient, and streamlined experience for a user. Additionally or alternatively, the methods described herein reduce the processor tasking and power consumption of the electronic device using caching compared with referencing the information from other sources or requiring additional inputs to prevent or resolve occlusion.

In some examples, a method is performed at an electronic device in communication with one or more displays and/or one or more optical sensors. In some examples, the electronic device captures, via one or more optical sensors, one or more first optical captures of a first object in a physical environment. In some examples, at least a portion of the one or more first optical captures are cached for reference (e.g., in a memory, buffer, etc.). In some examples, in accordance with detecting, in the one or more first optical captures one or more portions of a user directed to the first object that satisfy one or more first criteria (e.g., object-interaction gesture or a portion thereof), the electronic device captures one or more second optical captures of the first object. In some examples, in response to capturing the one or more second optical captures of the first object, in accordance with a determination that the one or more portions of the user (or any other object) occlude a first region of the first object from a viewpoint of the electronic device (e.g., as reflected by the one or more second optical captures), the electronic device initiates one or more first operations (Optical Character Recognition (OCR), non-character recognition) on the one or more first optical captures of the first region of the first object.

In some examples, an electronic device in communication with one or more displays and/or one or more optical sensors captures a plurality of optical captures. The optical captures include at least a first object in a physical environment. In some examples, at least a first portion of the plurality of optical captures are cached for reference. In some examples, in accordance with a determination that one or more criteria are satisfied, the one or more criteria including a criterion that is satisfied when an object-interaction gesture directed to the first object is detected and a criterion that is satisfied when at least a portion of the first object is occluded (e.g., by a portion of the user and/or by one or more other objects) in a second portion of the plurality of optical captures, the electronic device obtains the cached first portion of the plurality of optical captures including a non-occluded view of at least the potion of the object that was occluded in the second portion of the plurality of optical captures. The non-occluded view can be used for processing in accordance with the object-interaction gesture (e.g., performing Optical Character Recognition (OCR), non-character recognition, etc.).

In some examples, one or more first optical captures serve as a cached visual reference of the physical environment. For example, an electronic device in communication with one or more displays and/or one or more optical sensors, optionally captures, via the one or more optical sensors, one or more first optical captures of a first object in a physical environment. Additionally or alternatively, optical captures by another device or representations based thereon can be obtained by the electronic device. The electronic device can process these one or more first optical captures or send the optical captures to another device for processing. The processing optionally includes predicting one or more interactions with the one or more objects in the physical environment and/or one or more virtual objects presented via the electronic device. Additionally or alternatively, the processing optionally includes object recognition and/or scene understanding, which are optionally used to predicting the one or more interactions with the one or more first objects in the first physical environment. For example, the one or more interactions can correspond to a request for informational content corresponding to one or more of the objects. To improve performance (e.g., faster query speed and/or display of informational content), the electronic device optionally stores, in cache or other memory, the informational content corresponding to the predicted interactions/objects. After storing the informational content corresponding to the objects and/or the three-dimensional environment, the electronic device receives input corresponding to an interaction with an object and/or with the three-dimensional environment. In response to receiving the input, and in accordance with a determination that one or more first criteria are satisfied, the electronic device obtains and presents the relevant informational content corresponding to the interaction with an object from the cache or other memory. In some examples, the input and the satisfaction of the one or more first criteria correspond to an object-interaction gesture or a command (e.g., a verbal command to a natural language digital assistant).

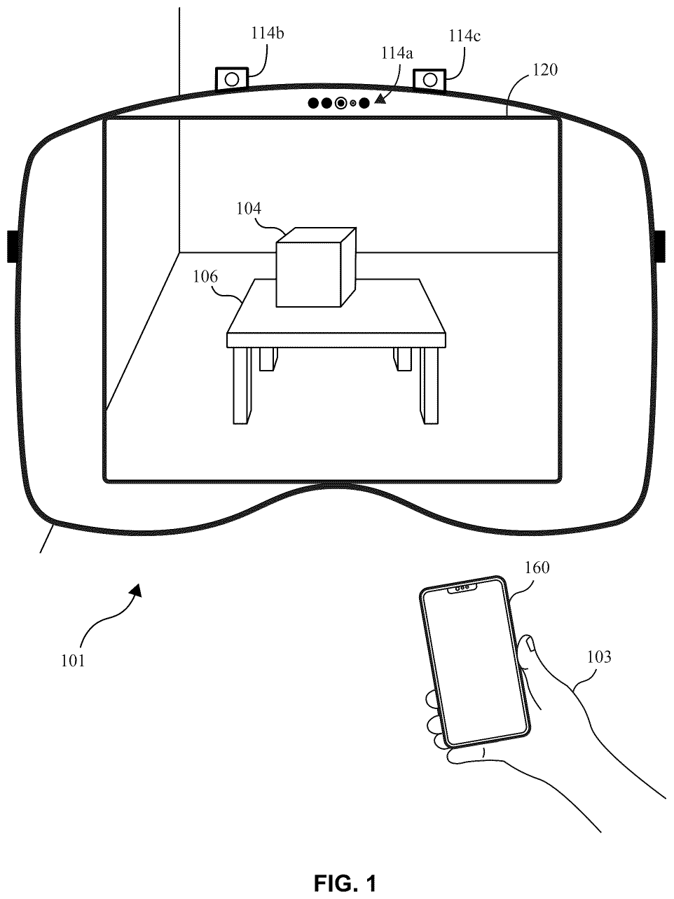

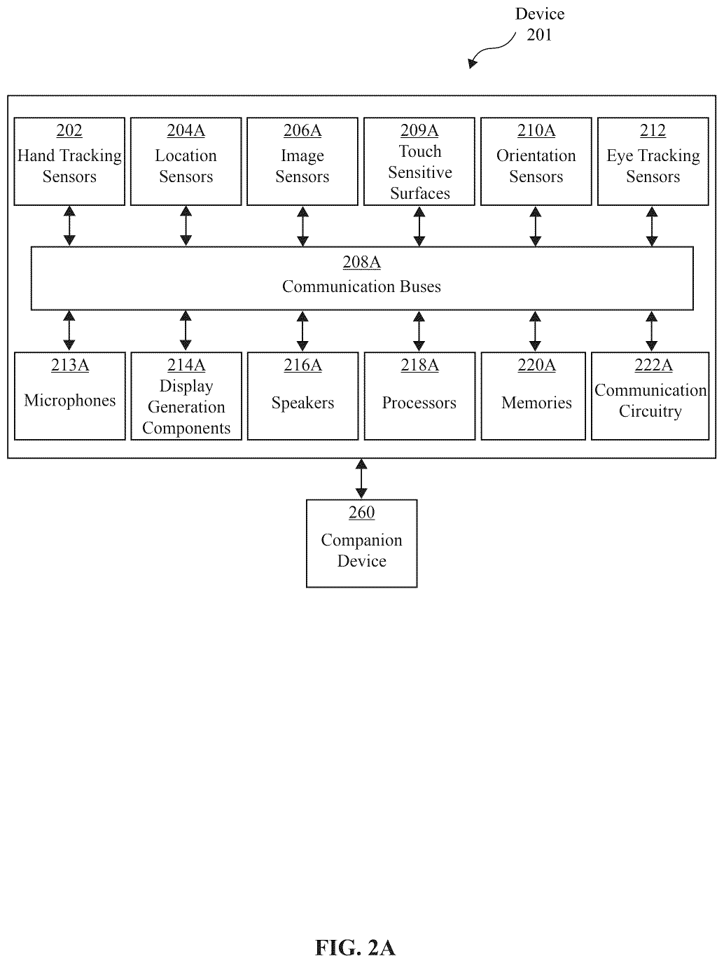

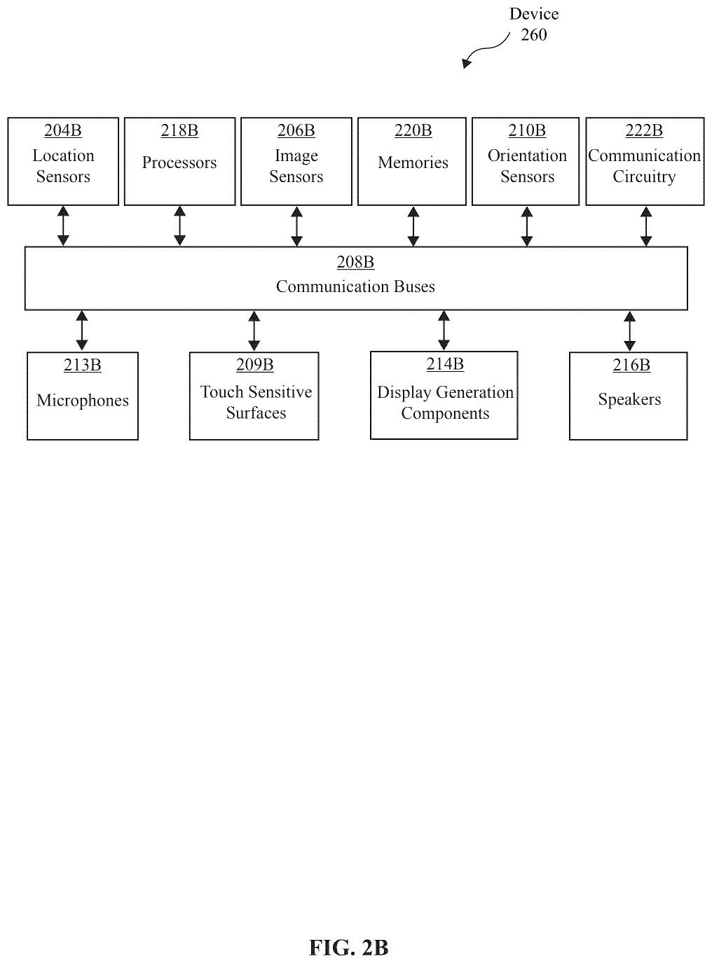

FIG. 1 illustrates an electronic device 101 presenting a three-dimensional environment (e.g., an extended reality (XR) environment or a computer-generated reality (CGR) environment, optionally including representations of physical and/or virtual objects), according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of the physical environment including table 106 (illustrated in the field of view of electronic device 101).

In some examples, as shown in FIG. 1, electronic device 101 includes one or more internal image sensors 114a oriented towards a face of the user (e.g., eye tracking cameras as described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user. In some examples, the field of view visible to the user is the same as a field of view of external image sensors 114b and 114c. For example, when display 120 is optionally part of a head-mounted device, the field of view of display 120 is optionally the same as or similar to the field of view of the user's eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user's eyes. A viewpoint of a user determines what content is visible in the field of view, a viewpoint generally specifies a location and a direction relative to the three-dimensional environment. As the viewpoint of a user shifts, the field of view of the three-dimensional environment will also shift accordingly. In some examples, electronic device 101 may be an optical see-through device in which display 120 is a transparent or translucent display through which portions of the physical environment may be directly viewed. In some examples, display 120 may be included within a transparent lens and may overlap all or a portion of the transparent lens. In other examples, electronic device may be a video-passthrough device in which display 120 is an opaque display configured to display images of the physical environment using images captured by external image sensors 114b and 114c. While a single display is shown in FIG. 1, it is understood that display 120 optionally includes more than one display. For example, display 120 optionally includes a stereo pair of displays (e.g., left and right display panels for the left and right eyes of the user, respectively) having displayed outputs that are merged (e.g., by the user's brain) to create the view of the content shown in FIG. 1. In some examples, as discussed in more detail below with reference to FIGS. 2A-2B, the display 120 includes or corresponds to a transparent or translucent surface (e.g., a lens) that is not equipped with display capability (e.g., and is therefore unable to generate and display the virtual object 104) and alternatively presents a direct view of the physical environment in the user's field of view (e.g., the field of view of the user's eyes).

In some examples, the electronic device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 is displayed on the surface of the table 106 in the three-dimensional environment displayed via the display 120 of the electronic device 101 in response to detecting the planar surface of table 106 in the physical environment 100.

It is understood that virtual object 104 is a representative virtual object and one or more different virtual objects (e.g., of various dimensionality such as two-dimensional or other three-dimensional virtual objects) can be included and rendered in a three-dimensional environment. For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of electronic device 101 and interpreted as one or more user inputs directed to content displayed by electronic device 101. Additionally or alternatively, in some examples, the one or more user inputs interpreted by the electronic device 101 as being directed to content displayed by electronic device 101 (e.g., the virtual object 104) are detected via one or more hardware input devices (e.g., controllers, touch pads, proximity sensors, buttons, sliders, knobs, etc.) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, the electronic device 101 may be configured to communicate with a second electronic device, such as a companion device. For example, as illustrated in FIG. 1, the electronic device 101 is optionally in communication with electronic device 160. In some examples, electronic device 160 corresponds to a mobile electronic device, such as a smartphone, a tablet computer, a smart watch, a laptop computer, or other electronic device. In some examples, electronic device 160 corresponds to a non-mobile electronic device, which is generally stationary and not easily moved within the physical environment (e.g., desktop computer, server, etc.). Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned on (e.g., mounted to) a head of a user and the electronic device 160 may be positioned near electronic device 101, such as in a hand 103 of the user (e.g., the hand 103 is holding the electronic device 160), a pocket or bag of the user, or a surface near the user. The electronic device 101 and the electronic device 160 are optionally associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, displaying an object in a three-dimensional environment is caused by or enables interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the descriptions that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices according to some examples of the disclosure. In some examples, electronic device 201 and/or electronic device 260 include one or more electronic devices. For example, the electronic device 201 may be a portable device, an auxiliary device in communication with another device, a head-mounted display, a head-worn speaker, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes one or more sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), etc. The electronic device 201 optionally includes one or more output devices, such as one or more display generation components 214A, optionally corresponding to display 120 in FIG. 1, one or more speakers 216A, one or more haptic output devices (not shown), etc. The electronic device 201 optionally includes one or more processors 218A, one or more memories 220A, and/or communication circuitry 222A. One or more communication buses 208A are optionally used for communication between the above-mentioned components of electronic device 201.

Additionally, the electronic device 260 optionally includes the same or similar components as the electronic device 201. For example, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260.

The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201. For example, in some examples, the electronic device 260 processes sensor inputs from electronic devices 201 and 260 and/or generates content for display using display generation components 214A of electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband (“UWB”), high frequency systems (e.g., 900 MHz, 2.4 GHz, and 5.6 GHz communication systems), or any other communications protocol, or any combination thereof.

One or more processors 218A, 218B include one or more general processors, one or more graphics processors, and/or one or more digital signal processors. In some examples, one or more processors 218A, 218B include one or more microprocessors, one or more central processing units, one or more application-specific integrated circuits, one or more field-programmable gate arrays, one or more programmable logic devices, or a combination of such devices. In some examples, memories 220A and/or 220B are a non-transitory computer-readable storage medium (e.g., flash memory, random access memory, or other volatile or non-volatile memory or storage) that stores computer-readable instructions configured to be executed by the one or more processors 218A, 218B to perform the techniques, processes, and/or methods described herein. In some examples, memories 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, the one or more display generation components 214A, 214B include multiple displays. In some examples, the one or more display generation components 214A, 214B can include a display with touch capability (e.g., a touch screen), a projector, a holographic projector, a retinal projector, a transparent or translucent display, etc. In some examples, the electronic device does not include one or more display generation components 214A or 214B. For example, instead of the one or more display generation components 214A or 214B, some electronic devices include transparent or translucent lenses or other surfaces that are not configured to display or present virtual content. However, it should be understood that, in such instances, the electronic device 201 and/or the electronic device 260 are optionally equipped with one or more of the other components illustrated in FIGS. 2A and 2B and described herein, such as the one or more hand tracking sensors 202, one or more eye tracking sensors 212, one or more image sensors 206A, and/or the one or more motion and/or orientations sensors 210A. Alternatively, in some examples, the one or more display generation components 214A or 214B are provided separately from the electronic devices 201 and/or 260. For example, the one or more display generation components 214A, 214B are in communication with the electronic device 201 (and/or electronic device 260), but are not integrated with the electronic device 201 and/or electronic device 260 (e.g., within a housing of the electronic devices 201, 260). In some examples, electronic devices 201 and 260 include one or more touch-sensitive surfaces 209A and 209B, respectively, for receiving user inputs, such as tap inputs and swipe inputs or other gestures (e.g., hand-based or finger-based gestures). In some examples, the one or more display generation components 214A, 214B and the one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally include one or more image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensors 206A or 206B are included in an electronic device different from the electronic devices 201 and/or 260. For example, the one or more image sensors 206A, 206B are in communication with the electronic device 201, 260, but are not integrated with the electronic device 201, 260 (e.g., within a housing of the electronic device 201, 260). Particularly, in some examples, the one or more cameras of the one or more image sensors 206A, 206B are integrated with and/or coupled to one or more separate devices from the electronic devices 201 and/or 260 (e.g., but are in communication with the electronic devices 201 and/or 260), such as one or more input and/or output devices (e.g., one or more speakers and/or one or more microphones, such as earphones or headphones) that include the one or more image sensors 206A, 206B. In some examples, electronic device 201 or electronic device 260 corresponds to a head-worn speaker (e.g., headphones or earbuds). In such instances, the electronic device 201 or the electronic device 260 is equipped with a subset of the other components illustrated in FIGS. 2A and 2B and described herein. In some such examples, the electronic device 201 or the electronic device 260 is equipped with one or more image sensors 206A, 206B, the one or more motion and/or orientations sensors 210A, 210B, and/or speakers 216A, 216B.

In some examples, electronic device 201, 260 uses CCD sensors, event cameras, and depth sensors in combination to detect the physical environment around electronic device 201, 260. In some examples, the one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic device 201, 260 uses the one or more image sensors 206A, 206B to detect the position and orientation of electronic device 201, 260 and/or the one or more display generation components 214A, 214B in the real-world environment. For example, electronic device 201, 260 uses the one or more image sensors 206A, 206B to track the position and orientation of the one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses the one or more microphones 213A, 213B to detect sound from the user and/or the real-world environment of the user. In some examples, the one or more microphones 213A, 213B include an array of microphones (e.g., a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201 and/or the one or more display generation components 214A and a location of electronic device 260 and/or the one or more display generation components 214B, respectively. For example, the one or more location sensors 204A, 204B can include a global positioning system (GPS) receiver that receives data from one or more satellites and allows electronic device 201, 260 to determine the absolute position of the electronic device in the physical world.

Electronic devices 201 and 260 include one or more orientation sensors 210A and 210B, respectively, for detecting orientation and/or movement of electronic device 201 and/or the one or more display generation components 214A and orientation and/or movement of electronic device 260 and/or the one or more display generation components 214B, respectively. For example, electronic device 201, 260 uses the one or more orientation sensors 210A, 210B to track changes in the position and/or orientation of electronic device 201, 260 and/or the one or more display generation components 214A, 214B, such as with respect to physical objects in the real-world environment. The one or more orientation sensors 210A, 210B optionally include one or more gyroscopes and/or one or more accelerometers.

Electronic device 201 includes one or more hand tracking sensors 202 and/or one or more eye tracking sensors 212, in some examples. It is understood, that although referred to as hand tracking or eye tracking sensors, that electronic device 201 additionally or alternatively optionally includes one or more other body tracking sensors, such as one or more leg, one or more torso and/or one or more head tracking sensors. The one or more hand tracking sensors 202 are configured to track the position and/or location of one or more portions of the user's hands, and/or motions of one or more portions of the user's hands with respect to the three-dimensional environment, relative to the one or more display generation components 214A, and/or relative to another defined coordinate system. The one or more eye tracking sensors 212 are configured to track the position and movement of a user's gaze (e.g., a user's attention, including eyes, face, or head, more generally) with respect to the real-world or three-dimensional environment and/or relative to the one or more display generation components 214A. In some examples, the one or more hand tracking sensors 202 and/or the one or more eye tracking sensors 212 are implemented together with the one or more display generation components 214A. In some examples, the one or more hand tracking sensors 202 and/or the one or more eye tracking sensors 212 are implemented separate from the one or more display generation components 214A. In some examples, electronic device 201 alternatively does not include the one or more hand tracking sensors 202 and/or the one or more eye tracking sensors 212. In some such examples, the one or more display generation components 214A may be utilized by the electronic device 260 to provide a three-dimensional environment and the electronic device 260 may utilize input and other data gathered via the other one or more sensors (e.g., the one or more location sensors 204A, the one or more image sensors 206A, the one or more touch-sensitive surfaces 209A, the one or more motion and/or orientation sensors 210A, and/or the one or more microphones 213A or other audio sensors) of the electronic device 201 as input and data that is processed by the one or more processors 218B of the electronic device 260. Additionally or alternatively, electronic device 260 optionally does not include other components shown in FIG. 2B, such as the one or more location sensors 204B, the one or more image sensors 206B, the one or more touch-sensitive surfaces 209B, etc. In some such examples, the one or more display generation components 214A may be utilized by the electronic device 260 to provide a three-dimensional environment and the electronic device 260 may utilize input and other data gathered via the one or more motion and/or orientation sensors 210A (and/or the one or more microphones 213A) of the electronic device 201 as input.

In some examples, the one or more hand tracking sensors 202 (and/or other body tracking sensors, such as leg, torso and/or head tracking sensors) can use the one or more image sensors 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, the one or more image sensors 206A are positioned relative to the user to define a field of view of the one or more image sensors 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, the one or more eye tracking sensors 212 include at least one eye tracking camera (e.g., IR cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more of) the electronic devices may include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

Attention is now directed towards interactions with one or more virtual objects that are displayed in a three-dimensional environment at one or more electronic devices (e.g., corresponding to electronic devices 201 and/or 260). For example, the one or more interactions optionally include an object-interaction gesture with a physical object in the physical environment. In some examples, the environment, one or more objects in the environment, and/or the object interaction gesture can be detected or captured via one or more input devices of the electronic device. In some examples, when the electronic device detects the object-interaction gesture, the electronic device presents informational content corresponding to the object to which the object interaction gestures is directed.

However, as described herein, in some examples, one or more portions of the object can be occluded, such as by the object-interaction gesture. As described herein, the electronic device stores one or more optical captures of the physical environment and/or objects therein, that are subsequently used for implementing the functionality associated with the object interaction gesture when there is occlusion of the one or more portions of the object. Storing and accessing the one or more optical captures can improve performance of the functionality associated with an object-interaction gesture when occlusion occurs. For example, accessing stored optical captures can enable improved character or non-character recognition to identify correct informational content to present (e.g., compared with the informational content identified using one or more partially occluded captures of the object). Additionally or alternatively, storing optical captures can improve the speed of obtaining the correct informational content when occlusion occurs (e.g., compared with using subsequent optical captures without occlusion).

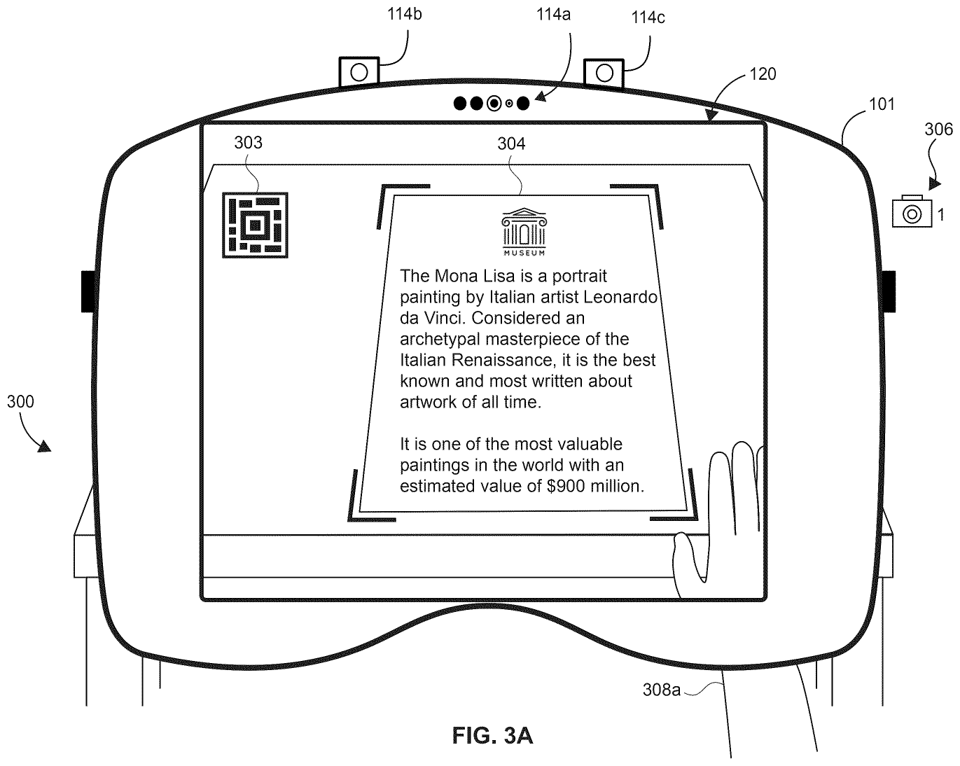

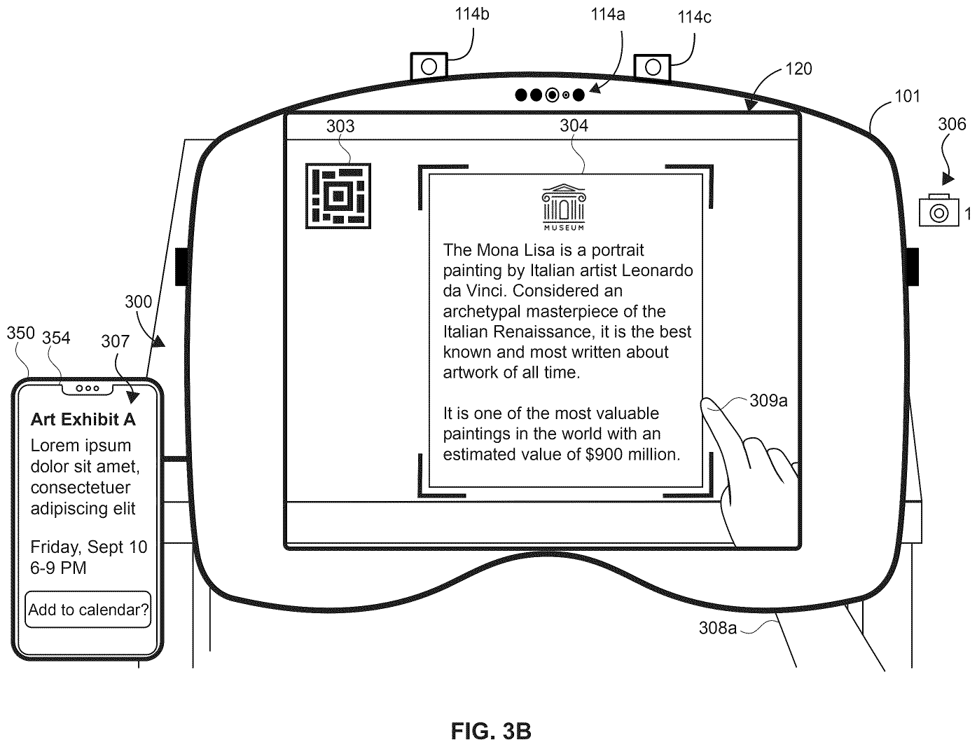

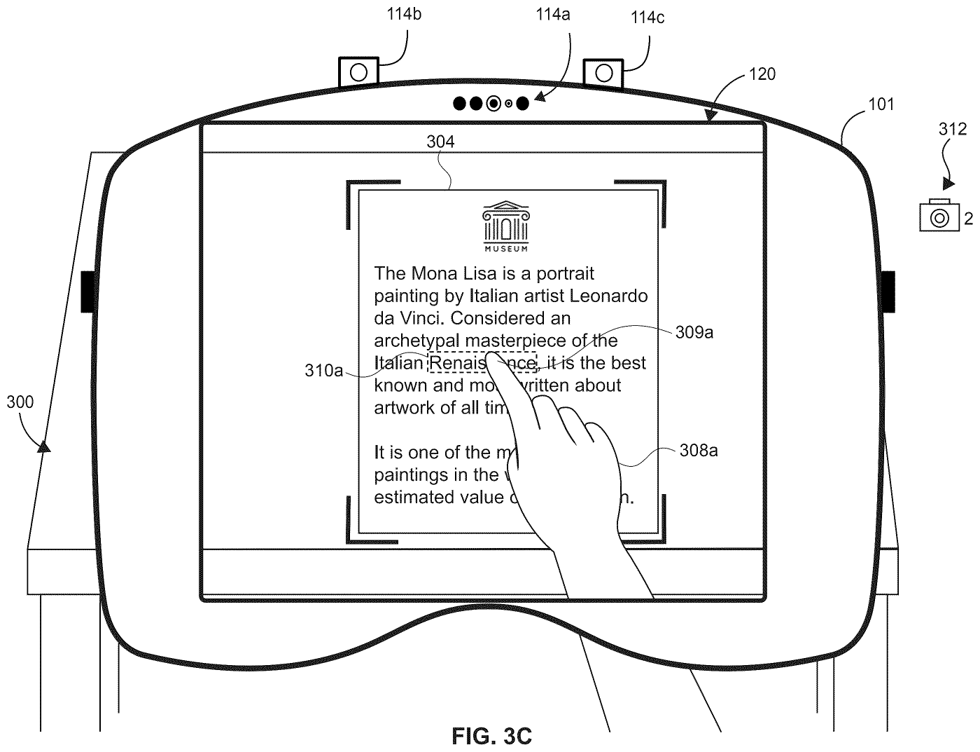

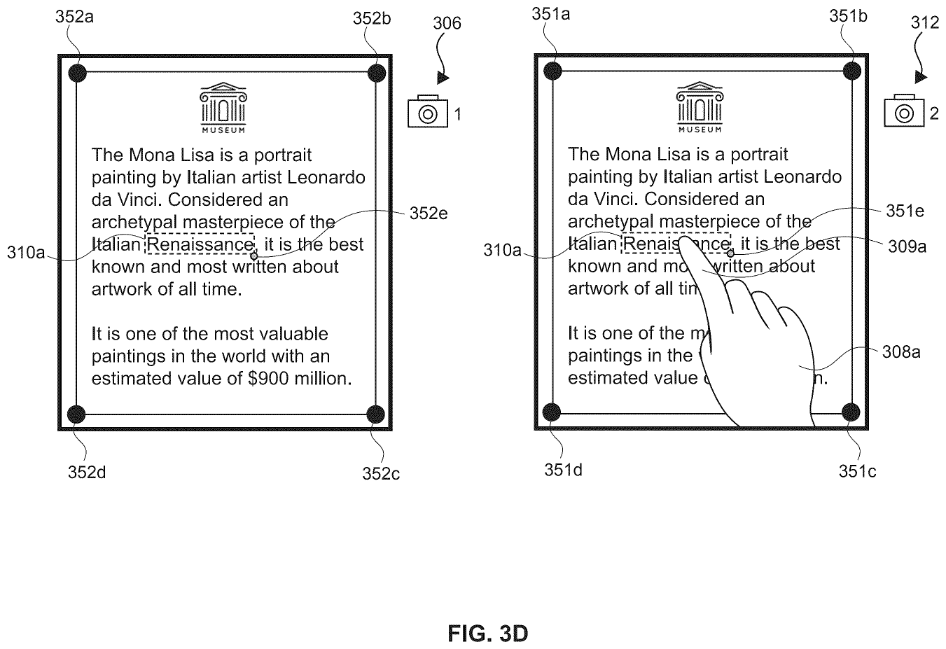

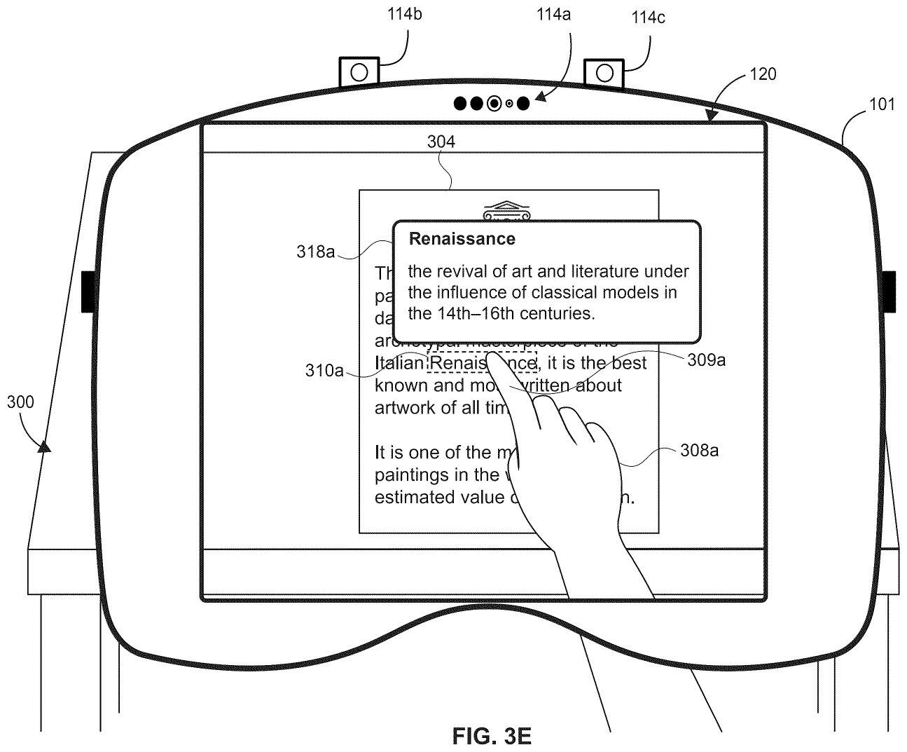

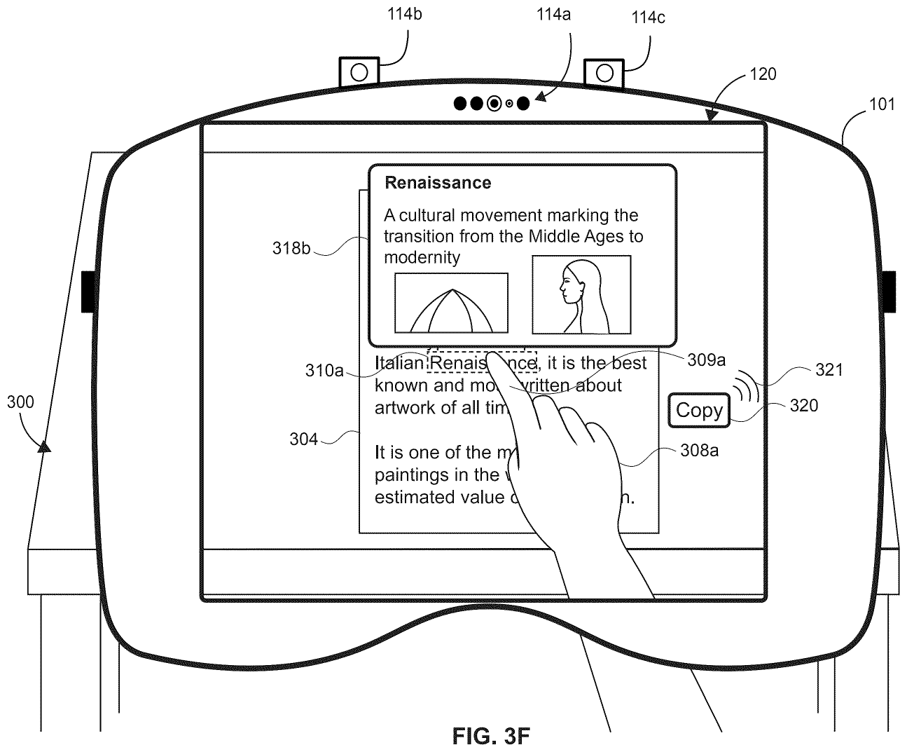

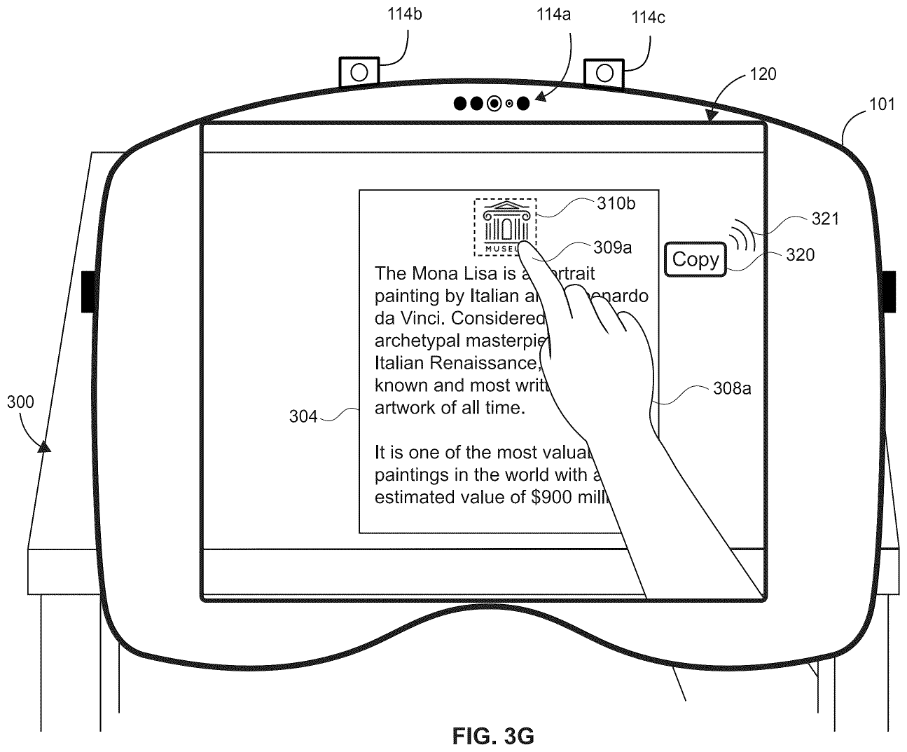

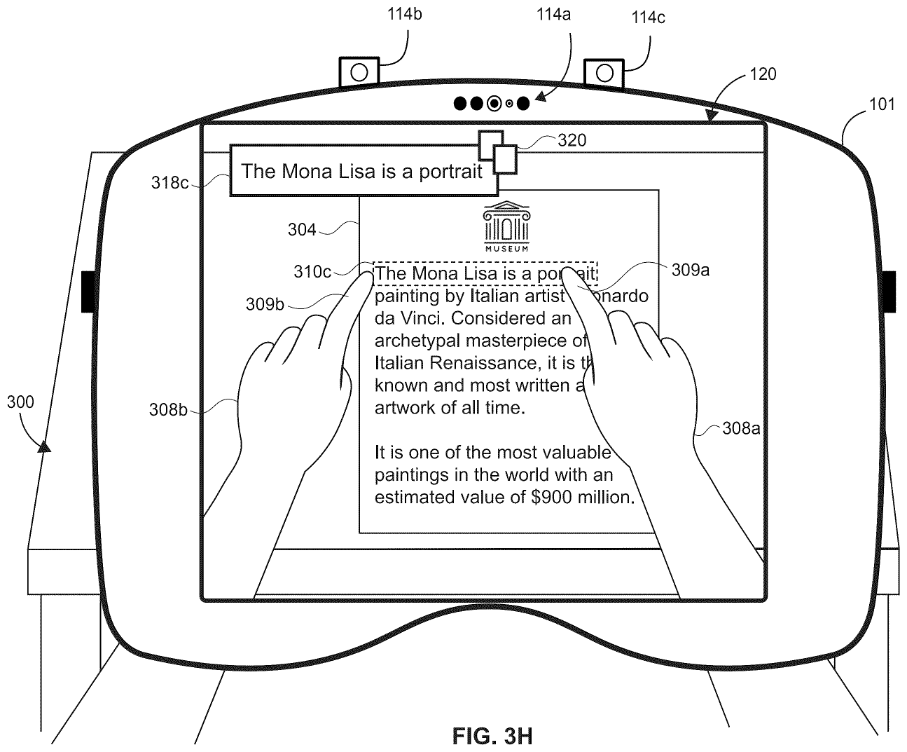

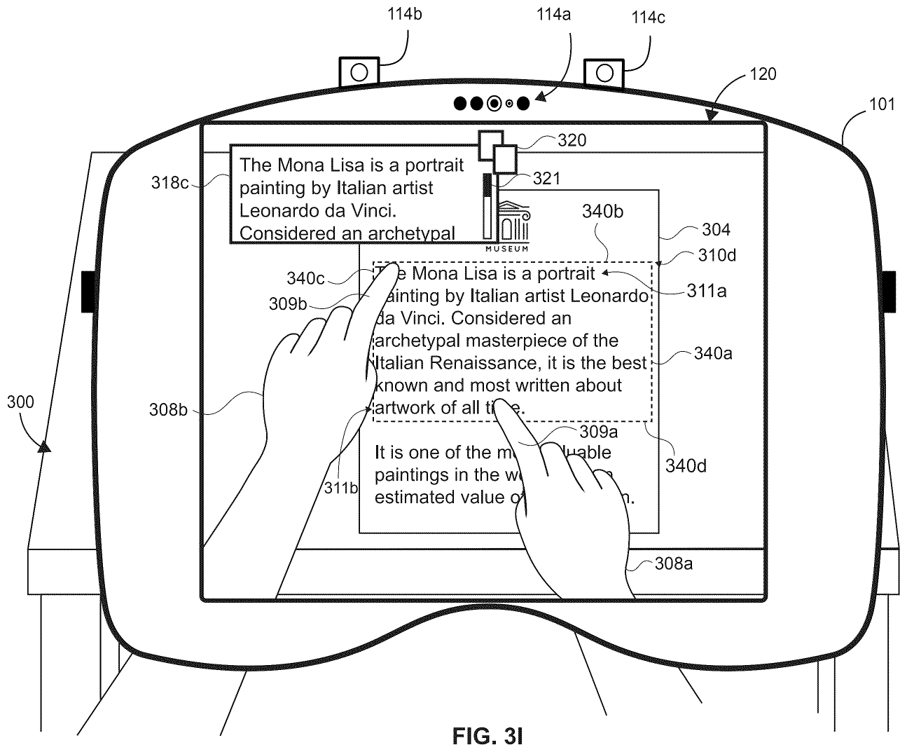

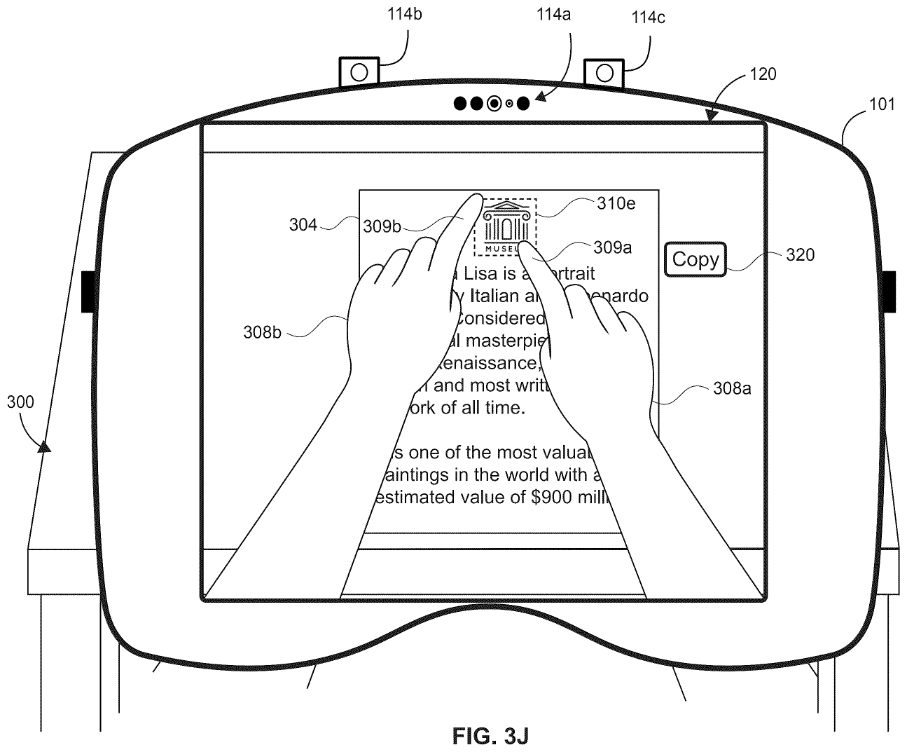

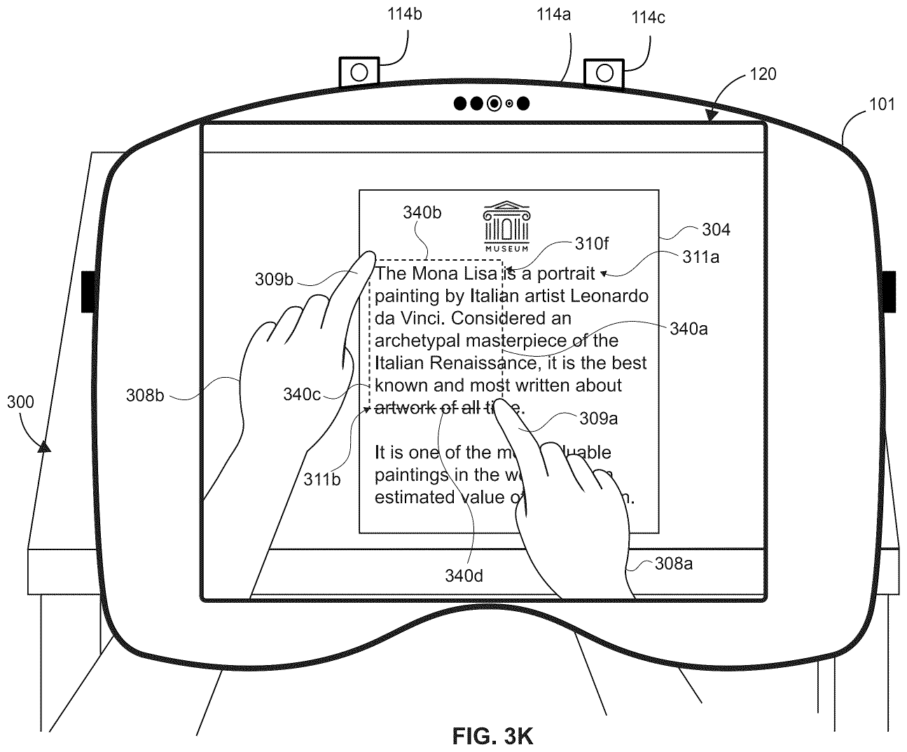

FIG. 3A-FIG. 3K illustrate various examples of an electronic device and user interactions with the electronic device, referencing stored optical captures when occlusion is detected, according to some examples of the disclosure. For example, FIG. 3A-FIG. 3F illustrate an object-interaction gesture including a pointing finger that occludes text in a first region, and use of stored optical captures corresponding to non-occluded views of the first region to enable presentation of information content associated with the text of the first region. FIG. 3G for example, illustrates an object-interaction gesture including a pointing finger that occludes graphical content, and use of stored optical captures corresponding to non-occluded views of the graphical content to enable presentation of information content associated with the graphical content. FIG. 3H-FIG. 3K illustrate multi-finger object-interaction gestures including multiple pointing fingers, at least one of which occludes text or graphical content, and use of stored optical captures corresponding to non-occluded views of the text or graphical content to enable presentation of information content associated with the text or graphical content. By referencing previously captured and stored optical captures corresponding to non-occluded views of the graphical content to enable presentation of information content associated with the graphical content, the electronic device avoids the capturing of additional optical captures, thus reducing processor tasking and power consumptions, results in a faster response upon a request for information (e.g., based on the occlusion of text or graphical content).

FIG. 3A illustrates an example electronic device including or in communication with one or more input devices (e.g., internal image sensors 114a, external image sensors 114b-114c, hand tracking sensors 202, eye-tracking sensors 212, etc.). In some examples, the electronic device presents a physical environment 300 (e.g., using transparent, or translucent lens). In some examples, the electronic device includes or is in communication with a one or more displays (e.g., one or more generation components 214). The electronic device 101 optionally has one or more characteristics of the electronic device or computer system, the one or more input devices, and/or the display generation components described with reference to FIG. 1-FIG. 2B.

In some examples, the electronic device is configured to provide a view of a physical environment 300 around an electronic device 101 and/or of a user of the electronic device. The physical environment 300 includes one or more objects. The examples described herein include, for instance, primarily focus on a user's interaction with an object 304 detected within the physical environment. Object 304 is shown as including textual information and/or graphical information. While particular focus is drawn to objects and regions of the physical environment 300 which include textual information, the present disclosure is optionally applied to regions within the physical environment 300 lacking textual information, including graphical information, and/or including other informational content.

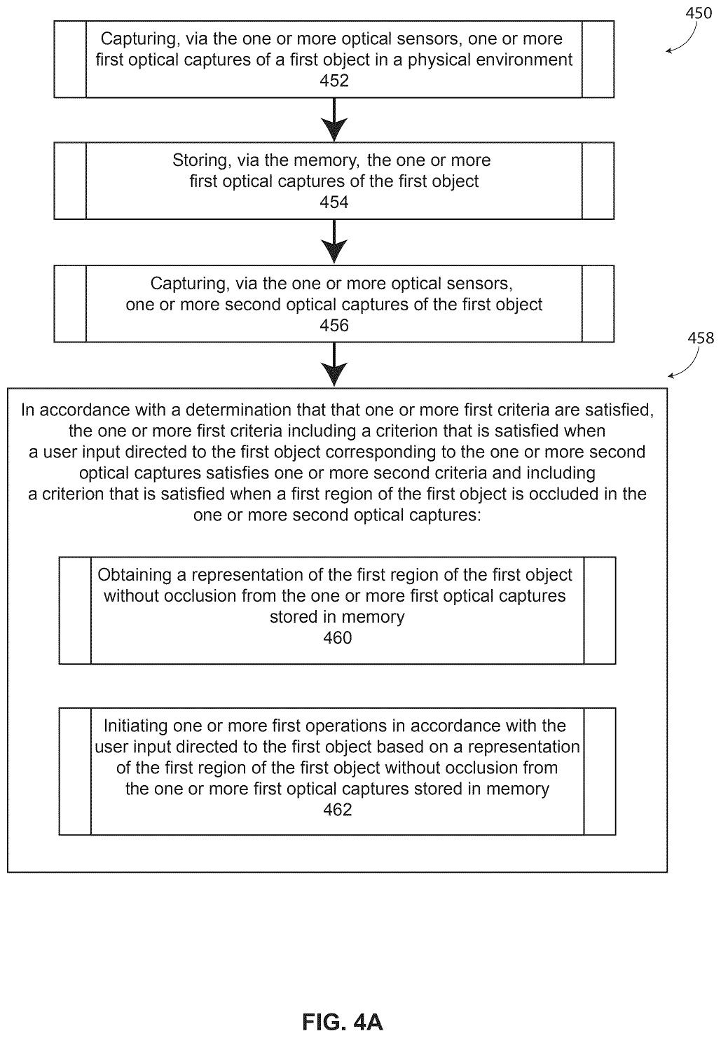

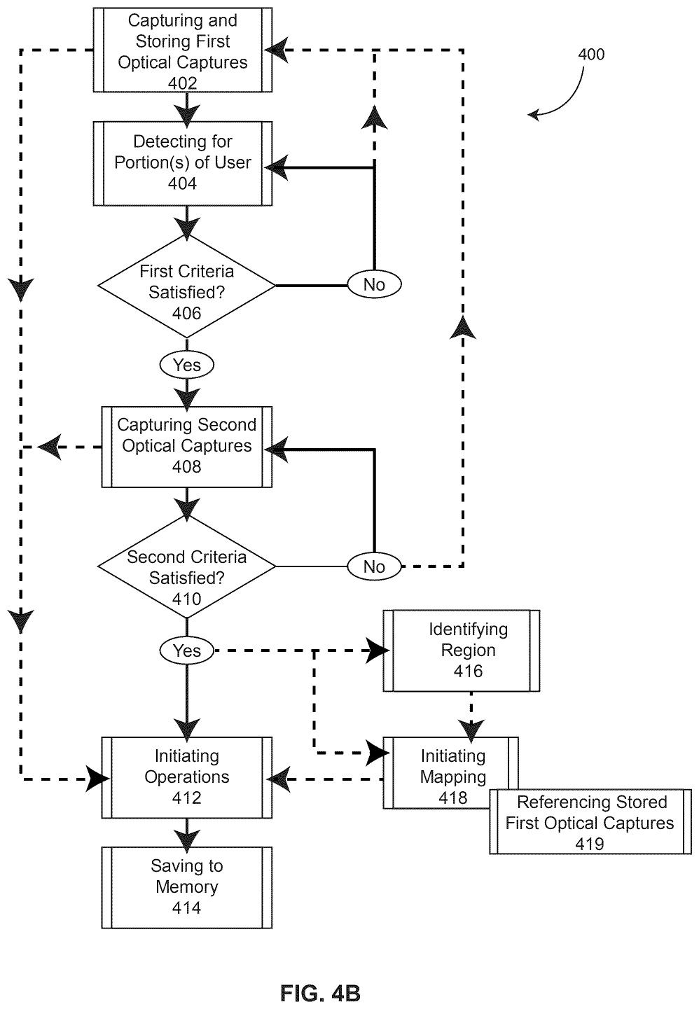

In some examples, such as illustrated in FIG. 3A-FIG. 3C, the electronic device captures optical captures of the environment. For example, one or more first optical captures 306 are indicated by a camera icon with label “1” in FIGS. 3A-3B and one or more second optical captures 312 are indicated by a camera icon label “2” in FIG. 3C. The one or more first optical captures 306 and one or more second optical captures 312 are also indicated in FIG. 3D. As described herein, the one or more first optical captures 306 precede the one or more second optical captures 312 in time. In some non-limiting examples, the one or more first optical captures correspond to captures prior to satisfaction of one or more first criteria (e.g., corresponding to captures at block 402 of FIG. 4B, or before block 406) and the one or more second optical captures correspond to captures after satisfaction of the one or more first criteria (e.g., corresponding to captures at block 408 of FIG. 4B, or after block 406). In some examples, the one or more first optical captures are captured at a different rate (e.g., lower frame rate) compared with the one or more second optical captures. The one or more first criteria in this context optionally indicate to the electronic device that the user wishes to perform one or more operations on the first region of the object 304 to which their attention corresponds.

The electronic device 101 optionally continuously captures optical captures. In some examples, the electronic device 101 initiates capturing one or more first optical captures 306 of the physical environment when initiation criteria are satisfied (e.g., electronic device detects user activity (e.g., via movement detection), electronic device is powered on, and/or a particular application installed on the electronic device is launched). For example, the electronic device 101 optionally initiates capturing the one or more first optical captures when (and optionally while) one or more portions of the user (e.g., hand 308a) are detected from the viewpoint of the electronic device, such as shown in FIG. 3A. As described in more detail herein, when the electronic device 101 detects that one or more portions of the user satisfy one or more second criteria (e.g., corresponding to an object-interaction gesture), the electronic device performs one or more operations. For example, when an object-interaction gesture by the one or more portions of the user is directed at an object, the object-interaction gesture can cause presentation of informational content associated with the object. In some examples, the one or more operations include text recognition (e.g., Optical Character Recognition (OCR)), or graphical recognition. Additionally, in some examples described herein, the one or more portions of the user occlude one or more portions of the representation of the object in the physical environment, such as textual information (e.g., first region 310a in FIG. 3C), which would interfere with one or more of these operations without the use of the non-occluded images described herein.

As mentioned above, in FIG. 3A, the electronic device 101 initiates capturing of first optical captures before occlusion of a representation of an object (e.g., by hand 308a and/or a finger of hand 308a). In some examples, when and/or while the electronic device 101 detects the presence of the hand 308a of the user from the viewpoint of the electronic device 101, the electronic device captures one or more first optical captures 306 of the physical environment 300. In some examples, when and/or while the electronic device 101 detects the presence of the hand 308a of the user from the viewpoint of the electronic device 101, within a specific region of the viewpoint of the electronic device 101 (e.g., indicative of the hands in a ready position, for possible invocation of an object-interaction gesture, rather than resting at the user's sides) the electronic device captures one or more first optical captures 306 of the physical environment 300. In some examples, as shown in FIG. 3A, physical environment 300 includes one or more objects, such as object 304, which optionally includes textual and/or graphical information. In some examples, the electronic device captures one or more first optical captures corresponding to the entire field of view of the electronic device 101 (e.g., including Quick Response (QR) code 303, object 304, and/or the hand 308a of the user). In some examples, the electronic device captures one or more first optical captures corresponding specifically to one or more objects within the representation of the physical environment, which optionally correspond to the location of the hand 308a of the user, or the representation of the hand 308a of the user, from the viewpoint of the electronic device 101. In some examples, the electronic device 101 captures one or more first optical captures corresponding to a subset of the field of view of the electronic device 101. Additionally or alternatively, the one or more first optical captures optionally correspond to one or more objects to which a gaze of the user is directed (e.g., detected via eye-tracking sensors 212 in FIG. 2A-FIG. 2B).

In some examples, as shown in FIG. 3B, the electronic device 101 is in communication with a second electronic device, such as second electronic device 350 or other mobile electronic device. It is understood that FIG. 3A—showing an electronic device 101—and FIG. 3B—showing an electronic device 101 in communication with a second electronic device—are non-limiting examples of implementations for the features and techniques described herein. For example, display functionality described herein is optionally implemented using one or more displays of electronic device 101 and/or using a display (e.g., touch screen 354) of the second electronic device. Additionally or alternatively, optical capture functionality (e.g., images) described herein is optionally implemented using one or more optical devices (e.g., cameras) of electronic device 101 and/or using one or more optical devices (e.g., cameras) of the second electronic device. Additionally, the storage of optical captures be in memory at either device.

Additionally or alternatively, in some examples, the electronic device 101 initiates capturing one or more first optical captures 306 upon detecting that one or more first criteria are satisfied. In some examples, as described above, the one or more first criteria include a criterion that is satisfied when the presence of the hand 308a of the user is visible from the viewpoint of the electronic device 101, such as shown in FIG. 3A. Additionally or alternatively, the one or more first criteria include other criteria satisfied based on one or more portions of the user. For example, the one or more first criteria optionally include a criterion that is satisfied when detecting that the hand 308a of the user is performing a gesture or aspects of a gesture (e.g., pose such as extended finger 309a), such as shown in FIG. 3B. In some examples, the one or more first criteria include other criteria satisfied when the one or more portion of the user (e.g., the hand or finger(s)) are within a threshold distance of, or within a threshold distance of overlapping, the object 304 (e.g., without occluding the object). In some examples, the one or more first criteria include a criterion satisfied when the one or more portion of the user or the electronic device (e.g., the head) have a velocity less than a threshold (e.g., a speed at which optical captures are not blurry, and/or that correspond with focus correlated with intention for an object-interaction gesture). In some examples, the one or more first criteria include a criterion satisfied when a gaze of a user is directed to a portion of the physical environment, optionally for a threshold amount of time or with a movement characteristic below a threshold amount. Additional or alternative criteria of the one or more first criteria may be a subset of the criteria for determining an object-interaction gesture is performed (e.g., one or more second criteria) are described herein. In some examples, the one or more criteria share one or more characteristics with the one or more criteria as described in relation to methods 400, 450, and 600 below.

When the electronic device 101 detects that the hand of the user satisfies one or more second criteria, different from the one or more first criteria, including a criterion that is satisfied when the hand or a portion of the hand forms a gesture (e.g., a pointing gesture, optionally that remains stationary for a threshold length of time) and/or is occluding a first region 310a of an object 304, such as shown in FIG. 3C, which optionally includes textual information, the electronic device 101 initiates referencing and/or performing one or more operations on the one or more previously captured optical captures, which include the occluded portion (e.g., first region 310a) of the object 304, as described below.

In some examples, as mentioned above, in FIG. 3C, the electronic device 101 detects the finger 309a of the hand 308a forming a gesture and/or occluding the first region 310a of the object 304. In some examples, the formation of a gesture and/or occlusion of the first region 310a by the finger 309a corresponds to a request to provide context, additional information, supplemental content, etc. corresponding to the textual information (e.g., the word) included in the first region 310a. In some examples, as mentioned above, when the electronic device 101 captures the second optical captures 312 in response to detecting that the one or more second criteria are satisfied (e.g., the finger 309a is forming a gesture and/or occluding a portion of the first region 310a), the second optical captures 312 includes images of the finger 309a occluding the first region 310a in the object 304. In some examples, the forming a gesture and/or occlusion of the first region 310a by the finger 309a in the second optical captures 312 provides the electronic device 101 with an indication of a particular region of the object 304 (e.g., the first region 310a) that is of interest to the user. However, utilizing solely the second optical captures 312 in FIG. 3C optionally prevents the electronic device 101 from performing an operation based on the textual information of the first region 310a due to the occlusion of the first region 310a by the finger 309a. Accordingly, as discussed below, in some examples, the electronic device 101a utilizes the first optical captures 306 captured in FIG. 3A or 3B to identify (e.g., via text or character recognition) the textual information of the first region 310a and perform a subsequent operation in response to detecting the extended first finger 309a that is directed to the first region 310a in FIG. 3C.

In some examples, when the electronic device 101 detects that the one or more first criteria are satisfied (e.g., one or more portions of the user satisfy the respective criteria of the one or more first criteria) and prior to detecting that the one or more second criteria are satisfied, the electronic device 101 optionally performs an operation based on information included in the physical environment 300. For example, as shown in FIG. 3B, the electronic device 101 detects the hand 308a performing the gesture (e.g., extended finger 309a) directed to the object 304 (e.g., the finger 309a is in contact with and/or is otherwise overlapping with a portion of the object 304, or is within a threshold distance of, or within a threshold distance of overlapping the object 304), optionally without occluding a particular portion of the object 304 (e.g., a particular word in the object 304)). Accordingly, in some examples, the electronic device 101 causes the second electronic device 350 (e.g., the phone) to perform an operation based on the textual information included in the object 304. For example, as shown in FIG. 3B, the electronic device 101 causes the second electronic device 350 (e.g., via data and/or other instructions provided by the electronic device 101) to display, via touch screen 354, suggestion 307. In some examples, the suggestion 307 corresponds to and/or relates to the textual information included in the object 304 and detected in the first optical captures 306. For example, the textual information included in the object 304 corresponds to information related to the Mona Lisa, which causes the electronic device 101 (e.g., based on OCR or other similar image processing technique) to cause the second electronic device 350 to display the suggestion 307 corresponding to an art exhibition (and optionally a selectable option to create an event corresponding to the art exhibition in a calendar application on the phone). It should be understood that, in some examples, as described below, the electronic device 101 displays a user interface that is similar to the suggestion 307 via the display 120 in addition to or alternatively to the second electronic device 350 displaying the suggestion 307.

In some examples, as shown in FIG. 3D, the electronic device 101 compares (e.g., maps, such as via holography) the second optical captures 312 to the first optical captures 306 to identify and/or recognize the textual information of the first region 310a in the object 304. For example, as shown in FIG. 3D, the electronic device 101 determines a location of the finger 309a relative to the textual information of the object 304. Particularly, in some examples, using the second optical captures 312, the electronic device 101 identifies portions of the textual information in the first region 310a that are not occluded by the finger 309a, such as non-occluded words, letters, and/or other characters, and/or portions of the textual information adjacent to the first region 310a, such as words, letters, and/or other characters next to, above, and/or below the textual information in the first region 310a. For example, in FIG. 3D, the electronic device 101 identifies and/or recognizes (e.g., via a machine learning or artificial intelligence (AI) model) the text “Renais nce” within the first region 310a and/or identifies and/or recognizes neighboring text “Italian,” “it is the best known,” and/or “archetypal masterpiece of the” in the object 304. In some examples, once the electronic device 101 determines the location of the object 304 to which the finger 309a is directed (e.g., the occluded portion of the first region 310a) in the second optical captures 312, the electronic device 101 identifies the corresponding location of the object 304 in the first optical captures 306. In some examples, as illustrated in FIG. 3D, the electronic device 101 identifies the first region 310a of the object 304 in the first optical captures 306, which does not include an occlusion. Accordingly, in some examples, the electronic device 101 is able to, using the first optical captures 306 of the same object 304, clearly identify and/or recognize the textual information (e.g., the word “Renaissance”) that is included in the first region 310a. In some examples, as discussed below, in response to the identification and/or recognition of the textual information of the first region 310a in the first optical captures 306, the electronic device 101 initiates generation of a representation of informational content corresponding to the textual information, such as shown in first user interface element 318a in FIG. 3E and/or second user interface element 318b in FIG. 3F.

Alternatively to the approach above, in some examples, the electronic device 101 utilizes portions (e.g., fragments) of the textual information in the first region 310a that is not occluded by the finger 309a to perform an operation based on the textual information in the first region 310a. In some examples, the electronic device optionally performs one or more first operations to recognize the text which remains visible while occluded (shown in FIG. 3C), and through analysis of permutations of the possible words which correspond to the occluded word, determines that the occluded term is “Renaissance. ” However, in some examples, identifying the occluded textual information is based, at least partially, on the amount of the text that is occluded, the uniqueness of the text, and/or which portion of the text is occluded. Additionally or alternatively, the electronic device optionally includes surrounding textual information (e.g., “Italian”) to provide further context to determine the occluded textual information. In some examples, the electronic device 101 determines the occluded information through one or more artificial intelligence (AI) models, and/or one or more Machine Learning (ML) models. In some examples, the occluded text is identified by the electronic device through referencing the one or more first optical captures 306 (e.g., as shown in FIG. 3A), which were captured prior to detecting that the one or more portions of the user occlude the first region 310a.

Additionally or alternatively, in some examples, after detecting that the one or more portions of the user occlude a first region 310a of the object 304 such as shown in FIG. 3C, when the electronic device 101 determines that the one or more portions of the user have moved and/or no longer satisfy one or more of the one or more second criteria (e.g., the extended finger 309a no longer occludes the textual information of the first region 310a of the object 304), the electronic device 101 optionally captures one or more third optical captures to capture the no-longer textual information for initiating generation of the representation of the textual information for presenting via the electronic device. The above-described strategy is optionally used additionally with or alternatively to other strategies for generating informational content for presenting described herein. For instance, when the informational content is not required immediately and/or the electronic device 101 receives an indication from the user that the informational content is to be saved for later use and/or reference, the electronic device 101 optionally employs the strategy using the one or more third optical captures to save battery power. Additionally or alternatively, when the electronic device 101 is unable to determine and/or identify the textual information in the first region 310a within the one or more first optical captures 306 (e.g., which corresponds to the textual information in the first region 310a within the one or more second optical captures 312 in FIG. 3D), such as when the textual information within the first region 310a is occluded prior to user input being detected, the use of the third optical captures allows the electronic device 101 to determine the first region 310a within the one or more third optical captures (e.g., which correspond to the first region 310a in the one or more second optical captures) once the first region 310a in the one or more third optical captures ceases to be occluded.

In some examples, when the electronic device 101 initiates generating the informational content and presents the informational content at the electronic device 101, the informational content corresponds to a dictionary entry (e.g., definition) such as shown in the first user interface element 318a in FIG. 3E. In some examples, the dictionary entry presented by the electronic device 101 is generated by referencing a predetermined dictionary entry corresponding to the textual information in the first region 310a. Additionally or alternatively, the dictionary entry is optionally generated using AI and/or machine learning generated informational content. As shown in FIG. 3E, the first user interface element 318a is presented at a location that is relative to the first region 310a of the object 304. For example, as shown in FIG. 3E, the electronic device 101 displays the first user interface element 318a at a location that is based on the first region 310a from the viewpoint of the electronic device 101, such as above and/or atop the first region 310a.

In some examples, when the electronic device 101 initiates generating the informational content and presents the informational content at the electronic device 101, the informational content alternatively corresponds to encyclopedic information (e.g., including one or more virtual images), such as shown in the second user interface element 318b in FIG. 3F. In some examples, the encyclopedic information presented by the electronic device 101 is generated by referencing a predetermined encyclopedic entry corresponding to the textual information in the first region 310a. Additionally or alternatively, the encyclopedic information is optionally generated using AI and/or machine learning generated informational content. In some examples, presenting the second user interface element 318b in FIG. 3F has one or more characteristics of presenting the first user interface element 318a discussed above with reference to FIG. 3E. In some examples, the electronic device 101 optionally presents the informational content via audible notification 321 (e.g., outputs, via one or more speakers, a transcript of the generated encyclopedic entry using a virtual assistant of an operating system of the electronic device 101).

In some examples, the electronic device 101 is configured to perform one or more second operations following the presentation of the informational content discussed above with reference to FIGS. 3E and 3F. For example, in FIG. 3F, the electronic device 101 detects user input corresponding to a request to copy the presented informational content (e.g., a request to save the informational content (e.g., the encyclopedia information) to memory of the electronic device 101). In some examples, the user input corresponding to the request to copy the presented informational content includes and/or corresponds to a voice command or other verbal input provided by the user. In some examples, the user input corresponding to the request to copy the presented informational content includes and/or corresponds to a hand-based gesture or input, such as maintaining the finger 309a directed to the first region 310a for more than a threshold amount of time (e.g., 0.5, 1, 1.5, 2, 3, 4, 5, etc. seconds) following the presentation of the informational content (e.g., the second user interface element 318b). In some examples, in response to detecting the user input, the electronic device 101 displays a user interface element 320 corresponding to copying the presented informational content. In some examples, when the electronic device 101 detects user input (e.g., a selection or other hand-based or gaze-based input) directed to the user interface element 320, the electronic device 101 optionally saves the informational content (e.g., encyclopedic information) to memory (e.g., one or more memories 220A and/or 220B in FIG. 2A-FIG. 2B), and optionally generates an audible notification 321 alerting the user that the informational content has been saved.

In some examples, the above-described approaches for performing an operation based on textual information is similarly applicable to graphical information to which an interaction gesture is directed and detected by the electronic device. For example, as shown in FIG. 3G, the electronic device 101 detects an interaction gesture performed by the hand 308a of the user (e.g., extended finger 309a), which satisfies the one or more first criteria discussed above. Additionally, as shown in FIG. 3G, when the electronic device 101 detects the interaction gesture performed by the hand 308a of the user, the electronic device 101 determines that the hand forms a gesture and/or at least a portion of a second region 310b of the object 304 is obscured by the finger 309a from the viewpoint of the electronic device 101, which satisfies the one or more second criteria discussed above. In some examples, in response to detecting the interaction gesture performed by the hand 308a that obscures a portion of the second region 310b, the electronic device 101 performs an operation based on the graphical information (e.g., the image or icon of a museum) included in the second region 310b. For example, as similarly discussed above, in some examples, the electronic device 101 utilizes one or more first optical captures that were captured prior to the finger 309a occluding the second region 310b (e.g., in response to detecting the hand 308a in the field of view of the electronic device 101, and/or in response to detecting movement of the hand 308a toward the second region 310b) and utilizes one or more second optical captures that were captured after detecting the finger 309a occluding the second region 310b to identify and/or recognize the graphical information of the second region 310b (e.g., based on a comparison and/or mapping between the one or more first optical captures and the one or more second optical captures).

In some examples, when the electronic device 101 identifies and/or recognizes the graphical information of the second region 310b (e.g., using OCR or other image recognition techniques), the electronic device 101 presents a user interface element that includes informational content that is based on and/or corresponds to the graphical information (e.g., the image or icon of the museum) of the second region 310b, as similarly discussed above. Additionally or alternatively, in some examples, the electronic device 101 facilitates a process to copy the graphical information of the second region 310b, as similarly discussed above. For instance, as shown in FIG. 3G, the electronic device 101 performs a graphical content search and/or performs an operation to save (e.g., copy), as indicated by user interface element 320, the graphical information to memory for later use. In some examples, when the electronic device saves the graphical information to memory, as similarly discussed above, the electronic device 101 also plays and/or outputs an audible notification 321 to indicate that graphical content has been saved.

In some examples, the above-described approaches for performing an operation based on textual and/or graphical information is similarly performed in response to detecting an interaction gesture provided by multiple hands and/or multiple fingers of a hand of the user. For example, in FIG. 3H, when the electronic device 101 detects a first portion of the user (e.g., first hand 308a, and/or a first extended finger 309a of the first hand 308a) and a second portion of the user (e.g., second hand 308b, and/or a second extended finger 309b of the second hand 308b), the first portion of the user and the second portion of the user are determined to be performing an interaction gesture (e.g., a same interaction gesture, or different interaction gesture). Alternatively or additionally, in some examples, the first portion of the user is determined to be performing a first interaction gesture, and the second portion of the user is determined to be performing a second interaction gesture (e.g., where the first interaction gesture and the second interaction gesture are determined to be performed concurrently or consecutively).

In some examples, as illustrated in FIG. 3H, when the first extended finger 309a of the first hand 308a, and the second extended finger 309b of the second hand 308b are detected by the electronic device 101 (optionally concurrently detected), the electronic device 101 determines that the first extended finger 309a and the second extended finger 309b are performing an interaction gesture in the field of view of the electronic device 101, which satisfies the one or more first criteria previously discussed above. Additionally, as shown in FIG. 3H, when the electronic device 101 detects the interaction gesture performed by the first hand 308a and the second hand 308b of the user, the electronic device 101 determines that at least a portion of a third region 310c of the object 304 is obscured by the first finger 309a from the viewpoint of the electronic device 101, which satisfies the one or more second criteria discussed above. For example, as shown in FIG. 3H, the first finger 309a is obscuring a portion of the word “portrait” in the third region 310c, while the second finger 309b is not obscuring a portion of the third region 310c. In some examples, the third region 310c is defined by (e.g., bound by) detected locations of the fingers 309a and 309b of the user. For example, in FIG. 3H, the third region 310c corresponds to a single line of textual information that originates at the location of the second finger 309b and ends at the location of the first finger 309a. In some examples, in response to detecting the interaction gesture performed by the first hand 308a and the second hand 308b that obscures a portion of the third region 310c, the electronic device 101 performs an operation based on the textual information included in the third region 310c. For example, as similarly discussed above, in some examples, the electronic device 101 utilizes one or more first optical captures that were captured prior to the first finger 309a occluding the third region 310c (e.g., in response to detecting the hands 308a and/or 308b in the field of view of the electronic device 101 and/or in response to detecting movement of the hands 308a and/or 308b toward the third region 310c) and utilizes one or more second optical captures that were captured after detecting the first finger 309a occluding the third region 310c to identify and/or recognize the textual information of the third region 310c (e.g., based on a comparison, and/or mapping between the one or more first optical captures and the one or more second optical captures).

In some examples, when the electronic device 101 identifies and/or recognizes the graphical information of the second region 310b (e.g., using OCR or other image recognition techniques), the electronic device 101 presents a user interface element that includes informational content that is based on and/or corresponds to the graphical information (e.g., the image or icon of the museum) of the second region 310b, as similarly discussed above. Additionally or alternatively, in some examples, the electronic device 101 facilitates a process to save (e.g., copy), as indicated by user interface element 320, the textual information corresponding to the single line of textual information to memory (e.g., one or more memories 220A and/or 220B in FIG. 2A-FIG. 2B) for later use. In some examples, when the electronic device 101 saves the textual information to memory, the electronic device 101 also displays a representation of the copied text, as illustrated in user interface element 318c.

As another example, in FIG. 3I, the electronic device 101 detects the first extended finger 309a of the first hand 308a directed to a second line 311b of textual information of a fourth region 310d (e.g., a first paragraph) in the object 304, and the second extended finger 309b of the second hand 308b directed to a first line 311a of textual information in the fourth region 310d in the object 304, which satisfies the one or more first criteria described above. Additionally, in some examples, as shown in FIG. 3I, the electronic device 101 detects that the first finger 309a is obscuring a first portion of the fourth region 310d (e.g., obscuring the word “time” in the first paragraph) and the second finger 309b is obscuring a second portion of the fourth region 310d (e.g., obscuring the word “The” in the first paragraph), which satisfies the one or more second criteria discussed above. In some examples, as similarly described above, the fourth region 310d is defined by (e.g., bound by) detected locations of the fingers 309a and 309b of the user. For example, in FIG. 3I, the fourth region 310d corresponds to a paragraph of textual information that originates at the location of the second finger 309b and ends at the location of the first finger 309a. In some examples, in accordance with the determination that the extended first finger 309a and the extended second finger 309b correspond to a first interaction gesture requesting informational content corresponding to the first paragraph in the fourth region 310d, the electronic device 101 generates and presents a representation of informational content that is based on and/or corresponds to the textual information in the first paragraph of the fourth region 310d, such as similar to user interface element 318c in FIG. 3I. Additionally or alternatively, in some examples, the electronic device 101 facilitates a process to save (e.g., copy), as indicated by user interface element 320, the textual information corresponding to the first paragraph of textual information to memory (e.g., one or more memories 220A and/or 220B at FIG. 2A-FIG. 2B) for later use. In some examples, when the electronic device 101 saves the textual information to memory, the electronic device 101 also displays a representation of the copied text, as illustrated in the user interface element 318c.

In some examples, such as illustrated in FIG. 3J, when a first extended finger 309a of the first hand 308a is detected as corresponding to a first portion of a fifth region 310e of the object 304 corresponding to graphical content (e.g., a museum logo or icon) and a second extended finger 309b of the second hand 308b is detected as corresponding to a second portion of the fifth region 310e, the electronic device 101 determines that the first extended finger 309a and the second extended finger 309b correspond to a first interaction gesture requesting informational content corresponding to the graphical content of the fifth region 310e. In some examples, as shown in FIG. 3J, the first finger 309a is obscuring a first portion of the graphical content while the second finger 309b is not obscuring a portion of the graphical content in the fifth region 310e. In some examples, as similarly discussed above, in response to detecting the first finger 309a directed to the first portion of the fifth region 310e and the second finger 309b directed to the second portion of the fifth region 310e, the electronic device 101 compares one or more first optical captures (e.g., maps) of the object 304 with one or more second optical captures of the object 304, as similarly discussed above, to identify and/or recognize the graphical content (e.g., the image or icon of the museum) in the fifth region 310e of the object 304. In some examples, as similarly discussed above, in accordance with a determination that the first interaction gesture provided by the first finger 309a and the second finger 309b satisfy the one or more first criteria and the one or more second criteria discussed above, the electronic device 101 initiates a process to save (e.g., copy), as indicated by user interface element 320, the graphical information in the fifth region 310e of the object 304 to memory (e.g., one or more memories 220A and/or 220B at FIG. 2A-FIG. 2B) for later use, as shown in FIG. 3J. For example, as previously discussed herein, the user interface element 320 is selectable (e.g., via hand-based and/or gaze-based user input) to copy the image or icon of the museum in the fifth region 310e.

In some examples, the electronic device 101 is configured to define a particular region of the object 304 for performing one or more of the above image processing techniques based on movement of one or more hands of the user. For example, in FIG. 3K, the electronic device 101 detects one or more first portions of the user (e.g., first extended finger 309a of the first hand 308a) and one or more second portions of the user (e.g., second extended finger 309b) originate from a first location of the object 304 (e.g., the word “The”), followed by movement (e.g., in a dragging motion) of the first extended finger 309a (and/or the second extended finger 309b) that results in the first extended finger 309a and the second extended finger 309b ending in different locations (e.g., a first location and a second location, or a second location and a third location) of the object 304 from the viewpoint of the electronic device 101. In some examples, the electronic device 101 defines a sixth region 310f of the object 304 based on the movement of the first finger 309a and/or the second finger 309b relative to the object 304 from the viewpoint of the electronic device 101. In some examples, the electronic device 101 defines the sixth region 310f of the object 304 during the movement of the first finger 309a and/or the second finger 309b. In some examples, the electronic device 101 defines the sixth region 310f of the object 304 after detecting a termination of the movement of the first finger 309a and/or the second finger 309b (e.g., in response to detecting that the first finger 309a, and/or the second finger 309b are no longer moving relative to the object 304). In some examples, following the determination of the sixth region 310f, the electronic device 101 performs one or more operations based on textual information in the sixth region 310f as similarly discussed above, such as presenting informational content based on and/or corresponding to the textual information in the sixth region 310f and/or initiating a process to save (e.g., copy) the textual information in the sixth region 310f of the object 304, and optionally based on a comparison between one or more first optical captures of the object 304 and one or more second optical captures of the object 304 as previously discussed herein.

In each of the aforementioned examples corresponding to FIG. 3A-FIG. 3K, the one or more first criteria, the one or more second criteria, one or more first portions of a user, one or more second portions of a user, and object interaction gestures, and operations, optionally share one or more characteristics with the respective one or more first criteria, the one or more second criteria, one or more first portions of a user, one or more second portions of a user, and object interaction gestures, and operations as described in relation to method 450, and method 600. Performing one or more operations on one or more first optical captures of a region of a first object as outlined above, wherein the first region corresponds to a region of the first object which is occluded in one or more second optical captures, reduces the number of inputs and/or time required to perform a particular operation, thereby reducing energy usage by the device, as one benefit.

As described herein, in some examples, an electronic device uses images captured before and/or after occlusion to enable interactions with objects that are at least partially occluded. For example, as described herein, an object-interaction directed at an object optionally includes touching the object with an extended pointing finger, which can cause the finger to partially occlude texts or graphics and which may degrade or prevent the electronic device from providing a response or the correct response. For example, the occlusion could impact the OCR or other textual content searching or graphical content searching. Images before the occlusion can be saved in memory (e.g., cache) and can be referenced to enable improved performance (e.g., enabling recognition of text or graphics that were otherwise occluded). Additionally or alternatively to one or more of the examples disclosed above, in some examples, one or more images after the occlusion can be used, but use of prior images improves the responsiveness of the system by not waiting for subsequent non-occlusion.

FIG. 4A illustrates a flow diagram for an example process for an electronic device interacting with the physical environment according to some examples of the disclosure. In some examples, an electronic device (e.g., electronic device 101, 201, and/or 260) performs method 450 as described herein. In some examples, one or more hardware modules/processors performs method 450 as described herein. Optionally, one or more operations of the method 450 are programmed in instructions stored using non-transitory computer readable storage media and executed by one or more processors (e.g., one or more processors 218). In some examples, one or more of the operations are performed by a computing system including a first electronic device (e.g., electronic device 101, 201, and/or 260) in communication with a second electronic device (e.g., second electronic device 350).

In some examples, an electronic device (e.g., one or more electronic devices 201 and/or 260 in FIG. 2A-FIG. 2B) presents, via one or more displays (e.g., one or more display generation components 214A and/or 214B in FIG. 2A-FIG. 2B), the physical environment or a representation thereof, which includes one or more physical objects (e.g., object 304 in physical environment 300 in FIG. 3A). The electronic device includes or is in communication with one or more processors and/or includes or is in communication with memory (e.g., one or more memories 220A and/or 220B in FIG. 2A-FIG. 2B). Additionally, the electronic device includes or in communication with one or more input devices including one or more optical sensors (e.g., one or more image sensors 206 in FIG. 2A-FIG. 2B).

In some examples, the electronic device captures a plurality of images. For example, the electronic device captures, at 452, via the one or more optical sensors, one or more first optical captures (e.g., one or more first optical captures 306 indicated in FIG. 3A) of a first object in the physical environment. In some examples, the electronic device stores, at 454, via the memory, the one or more first optical captures of the first object.

In some examples, the electronic device captures, at 456, via the one or more optical sensors, one or more second optical captures (e.g., one or more second optical captures 312 indicated in FIG. 3C) of the first object. In some examples, the one or more first optical captures and the one or more second optical captures are optical captures representing a consecutive period of time. For example, the one or more first optical captures can correspond to a buffered set of images preceding the one or more second images, and the buffered set of images is optional overwritten based on the size of the buffer. For example, the buffer optionally enables storing 1 second, 5 seconds, 10 seconds, 30 second, 1 minute, 5 minutes, 10 minutes, etc. worth of images that can be accessed in support of the object-interaction gesture described herein in the event of occlusion. In the context of this method, the one or more second images correspond to images in which the object-interaction gesture is detected.

In some examples, in accordance with a determination, at 458, that one or more first criteria are satisfied, the electronic device accesses the one or more first optical captures or aspects thereof. For example, the electronic device obtains, at 460, a representation of the first region of the first object without occlusion from the one or more first optical captures stored in memory (e.g., from first optical captures 306, previously stored to memory). In some examples, in accordance with a determination that the one or more first criteria are not satisfied, the electronic device forgoes accessing the one or more first optical captures or aspects thereof. For example, the electronic device forgoes obtaining the representation of the first region of the first object from the one or more first optical captures.

In some examples, the one or more first criteria include a criterion that is satisfied when a user input (e.g., extended finger 309a in FIG. 3C) directed to the first object corresponding to the one or more second optical captures satisfies one or more second criteria indicative of a valid object-interaction gestures. Additionally or alternatively, the one or more first criteria include a criterion that is satisfied when a first region (e.g., first region 310a in FIG. 3C) of the first object is occluded in the one or more second optical captures corresponding to the satisfaction of the one or more second criteria. As a result, at the time when the valid object-interaction gesture is received and the corresponding one or more second optical captures occlude a region of the object (e.g., including textual, or graphical, information), the electronic device may not be able to use the one or more second optical captures to accurately perform the operations described herein that rely on optical or graphical processing. As described herein, under these conditions, the electronic device can reference the one or more first optical captures stored in memory and use the one or more first optical captures, such as a portion of the one or more first optical captures corresponding to the first region that is occluded, to accurately perform the operations described herein based on the object-interaction gesture that rely on optical or graphical processing.

In accordance with a determination, at 458, that one or more first criteria are satisfied, the electronic device initiates, at 462, one or more first operations in accordance with the user input directed to the first object based on a representation of the first region (e.g., first region 310a in FIG. 3C) of the first object without occlusion from the one or more first optical captures stored in memory. For example, the one or more first operations optionally include presenting relevant information related to the information identified and detected in the physical environment. For example, the object-interaction gesture directed at the first object can cause audio, visual, or haptic output corresponding to information such as a definition, an image, an encyclopedic entry, and/or AI-generated content related to the target of the object-interaction gesture. In some examples, the object interaction gesture corresponds to text in a first region that is occluded in the one or more second mages but not occluded in the one or more first images. The one or more first operations optionally include optical character recognition performed on the one or more first optical captures of the first region of the first object, the one or more second optical captures, and/or a combination of the one or more first and one or more second optical captures. In some examples, the one or more first operations can include non-character recognition (e.g., graphical recognition) performed on the one or more first optical captures of the first region of the first object, the one or more second optical captures, and/or a combination of the one or more first and one or more second optical captures.

Additionally or alternatively, in some examples, the one or more first criteria include a criterion that is satisfied when the first region of the first object that is occluded includes textual information that is at least partially occluded. Additionally or alternatively, in some examples, initiating the one or more first operations comprises performing text recognition on first text corresponding to the representation of the first region of the first object without occlusion from the one or more first optical captures stored in memory. Additionally or alternatively, in some examples, initiating the one or more first operations comprises performing text recognition on second text corresponding to the first region or a region adjacent to the first region from the one or more second optical captures. Additionally or alternatively, in some examples, the one or more first criteria include a criterion that is satisfied when the first region of the first object that is occluded includes graphical information that is at least partially occluded. Additionally or alternatively, in some examples, initiating the one or more first operations comprises performing graphical recognition on first graphical information corresponding to the representation of the first region of the first object without occlusion from the one or more first optical captures stored in memory. Additionally or alternatively, in some examples, initiating the one or more first operations comprises performing graphical recognition on second graphical information corresponding to the first region or a region adjacent to the first region from the one or more second optical captures.

Additionally or alternatively, in some examples, the one or more first operations comprise presenting, via one or more displays in communication with the electronic device, first content including informational content associated with at least the first region of the first object. Additionally or alternatively, in some examples, the method further comprises displaying, via the one or more displays, a first user interface element including the informational content associated with at least the first region of the first object. Additionally or alternatively, in some examples, the one or more operations further comprise playing, via one or more speakers in communication with the electronic device, audio including the informational content associated with at least the first region of the first object. Additionally or alternatively, in some examples, the user input directed to the first object is an object-interaction gesture, and wherein the one or more second criteria include one or more of: a criterion that is satisfied when the attention of the user is directed to the first object; a criterion that is satisfied when the object-interaction gesture includes a pointing gesture by a finger of a hand of the user at the first object; a criterion that is satisfied when the finger is a pointer finger; a criterion that is satisfied when the non-pointing fingers of the hand of the user are in a fist; a criterion that is satisfied when the finger is touching the first object or within a threshold distance of the first object; a criterion that is satisfied when the pointing gesture is maintained for a threshold period of time; a criterion that is satisfied when the pointing gesture is maintained with less than a threshold amount of movement or velocity; or a criterion that is satisfied when a gaze of the user is directed at the first object or the finger of the hand of the user for a threshold amount of time.

Additionally or alternatively, in some examples, the method further comprises: capturing, via the one or more optical sensors, one or more third optical captures of the first object in the physical environment; storing, via the memory, the one or more third optical captures of the first object; capturing, via the one or more optical sensors, one or more fourth optical captures of the first object; and in accordance with a determination that the one or more first criteria are satisfied, the one or more first criteria including a criterion that is satisfied when a second region of the first object is occluded and a third region, different from the second region, is occluded in the one or more fourth optical captures, obtaining a representation of the second region and a representation of the third region of the first object without occlusion from the one or more third optical captures stored in memory, and initiating one or more second operations in accordance with the user input directed to the first object based on the representation of the second region and the representation of the third region of the first object without occlusion from the one or more third optical captures stored in memory. Additionally or alternatively, in some examples, the user input directed to the first object is an object-interaction gesture that includes a first extended finger of a first hand of a user of the electronic device, and a second extended finger of a second hand of the user. Additionally or alternatively, in some examples, the user input directed to the first object is an object-interaction gesture, and the one or more second criteria include one or more of: a criterion that is satisfied when a first finger of a first hand of a user of the electronic device and a second finger of a second hand of the user are directed to a first location corresponding to the first object; a criterion that is satisfied when a region defined by the first finger and the second finger corresponds to a first string of textual information; and a criterion that is satisfied when, while the first hand and the second hand are performing the object-interaction, the first finger and the second finger are static.

Additionally or alternatively, in some examples, in accordance with a determination that the second region and the third region of the first object are associated with a string of textual information, initiating the one or more second operations in accordance with the user input directed to the first object includes saving a representation of the string of textual information to the memory. Additionally or alternatively, in some examples, saving the representation of the string of textual information to the memory includes: identifying the string of textual information associated with the second region and the third region, including a portion of the second region and a portion of the third region occluded by one or more portions of a user of the electronic device; initiating the one or more second operations on the one or more third optical captures to generate a representation of the string of textual information; and saving the representation of the string of textual information to the memory. Additionally or alternatively, in some examples, in accordance with a determination that the second region and the third region of the first object are associated with multiple lines of textual information, initiating the one or more second operations in accordance with the user input directed to the first object includes saving a representation of the multiple lines of textual information to the memory. Additionally or alternatively, in some examples, saving the representation of the multiple lines of textual information to the memory includes identifying the multiple lines of textual information. In some examples, identifying the multiple lines of textual information comprises: establishing a first vertical boundary line originating from the second region that intersects a first horizontal boundary line originating from the third region; and establishing a second vertical boundary line originating from the third region that intersects a second horizontal boundary line originating from the second region, wherein the multiple lines of textual information correspond to textual information included within an area of the first vertical boundary line, the first horizontal boundary line, the second vertical boundary line, and the second horizontal boundary line.

Additionally or alternatively, in some examples, the one or more first criteria include a criterion that is satisfied when the first region of the first object that is occluded includes graphical information that is at least partially occluded by one or more portions of a user of the electronic device. Additionally or alternatively, in some examples, initiating the one or more first operations comprises performing graphical recognition on first graphics corresponding to the representation of the first region of the first object without occlusion from the one or more first optical captures stored in memory and/or on second graphics corresponding to the first region from the one or more second optical captures. Additionally or alternatively, in some examples, the one or more first optical captures and the one or more second optical captures are captured within a predetermined time period. Additionally or alternatively, in some examples, the method further comprises playing an audible response, via one or more speakers in communication with the electronic device, the informational content associated with at least the first region of the first object. Additionally or alternatively, in some examples, the method further comprises identifying a correspondence between the one or more second optical captures and the one or more first optical captures. Additionally or alternatively, in some examples, the user input directed to the first object is performed using one or more portions of a user of the electronic device, and identifying the correspondence between the one or more second optical captures and the one or more first optical captures further comprises: determining a first location of the one or more portions of the user within the one or more second optical captures when the user input directed to the first object corresponding to the one or more second optical captures satisfies the one or more second criteria, and determining a second location, corresponding to the first location of the one or more portions of the user in the one or more second optical captures, within the one or more first optical captures.

Some examples of the disclosure are directed to an electronic device, comprising: one or more processors in communication with one or more input devices including one or more optical sensors; memory; and one or more programs. In some examples, the one or more programs are stored in the memory and configured to be executed by the one or more processors, for performing any of the above methods.

Some examples of the disclosure are directed to a non-transitory computer readable storage medium storing one or more programs, the one or more programs comprising instructions, which when executed by one or more processors of an electronic device in communication with one or more input devices including one or more optical sensors, cause the electronic device to perform any of the above methods.

Attention is now directed to additional or alternative description of example interactions with one or more physical objects that are presented in a three-dimensional environment at an electronic device (e.g., corresponding to electronic devices 201 and/or 260). In some examples, while a physical environment is visible to an electronic device (e.g., visible to the user of the electronic device), the electronic device captures one or more first optical captures of a first object in the physical environment. After capturing the one or more optical captures, and in accordance with detecting one or more portions of a user directed to the first object, the electronic device captures one or more second optical captures of the first object. In some examples, detecting one or more portions of a user includes determining when the one or more portions of a user directed to the first object satisfy one or more first criteria (e.g., hand moving, hand performing a gesture, hand moving then static). Subsequent to capturing the one or more second optical captures, in accordance with determining that the one or more portions of the user directed to the first object satisfies one or more second criteria in the one or more second optical captures, the electronic device initiates one or more operations on the one or more first optical captures. In some examples, the one or more second criteria include a criterion that the one or more portions of the user occlude a first region of the first object from a viewpoint of the electronic device in the one or more second optical captures.

In some examples, a method 400 is performed by the electronic device, as illustrated in FIG. 4B for instance, wherein the electronic device allows for the recognition of informational content (e.g., textual, and/or graphical) on an object, region of an object, and/or the physical environment, wherein one or more portions of a user indicates that a user's attention is directed to the informational content. The electronic device captures one or more optical captures (e.g., images) which the electronic device subsequently recognizes the informational content therein. The method 400 further allows the electronic device to recognize informational content in one or more optical captures (e.g., one or more second optical captures) which has been occluded by the one or more portions of the user, by referencing previously captured optical captures (e.g., the one or more first optical captures) taken prior to the occlusion of the informational content.

For example, electronic device, the one or more input devices, and/or the display generation component have one or more characteristics of the computer system(s), the one or more input devices, and/or the display generation component(s) described with reference to FIGS. 1-2B. In some examples, the electronic device is configured to provide a view of a physical environment 300 (see FIG. 3A) surrounding a user, however the examples discussed herein are not limited thereto. The examples discussed herein include, for instance, a user's interaction with an object 304 detected within the physical environment. While particular focus is drawn to regions of the physical environment 300 which include textual information, the present disclosure is optionally applied to regions within the physical environment 300 lacking textual information, which optionally include graphical information, and/or other informational content.

In some examples, a method 400 is performed by the electronic device, as illustrated in FIG. 4B for instance, wherein the electronic device performs one or more operations to recognize informational content (e.g., textual, and/or graphical) on an object, region of an object, and/or the physical environment, wherein one or more portions of a user indicates that a user's attention is directed to the informational content. The electronic device captures one or more optical captures (e.g., images) which the electronic device subsequently recognizes the informational content therein. The method 400 further allows the electronic device to recognize informational content in one or more optical captures (e.g., one or more second optical captures), which has been occluded by the one or more portions of the user by referencing previously captured optical captures (e.g., one or more first optical captures).

In some examples, in response to capturing the one or more second optical captures, and in accordance with a determination that the one or more portions of a user (e.g., first hand 308a, and/or first extended finger 309a) directed to the object 304 satisfies one or more second criteria, including a criterion that the one or more portions of a user occlude a first region 310a of the object 304 from a viewpoint of the electronic device 101 in the one or more second optical captures, the electronic device 101 optically initiates one or more operations. In conjunction with the one or more second criteria being satisfied, the electronic device 101 optionally initiates one or more first operations on the one or more first optical captures of the physical environment.

In some examples, such as illustrated in FIGS. 3A-3C, after the one or more second criteria are satisfied, the electronic device 101 optionally initiates one or more first operations on the one or more first optical captures 306. In some examples, as illustrated in FIG. 3D, the electronic device 101 initiates a first operation on the one or more first optical captures 306 within a first region 310a associated with the one or more portions of a user (e.g., first hand 308a, and/or first extended finger 309a) which satisfy the one or more second criteria. For instance, as illustrated in FIGS. 3C-3D, the first extended finger 309a of the user is associated with a first region 310a, wherein the first region optionally includes informational content. The electronic device 101 detects that the first extended finger 309a of the user, in the one or more second optical captures 312, occludes a word (e.g., “Renaissance”) within the first region 310a. In accordance with detecting that the first extended finger 309a occludes informational content within the first region 310a of the one or more second optical captures 312, the electronic device 101 optionally initiates one or more first operations (e.g., text recognition, non-character recognition, Optical Character Recognition (OCR), and/or graphical content searching) on the one or more first optical captures 306 to identify the occluded informational content within the first region 310a of the one or more first optical captures which correspond with the location of the first region 310a within the one or more second optical captures 312. Identifying of the occluded informational content optionally includes determining when the informational content comprises textual information, graphical information, or a combination thereof. The use of one or more first operations configured to detect for the presence of textual and/or graphical information allows the electronic device 101 to confirm the presence of informational content and/or the type of informational content (e.g., text, and/or graphical) prior to performing subsequent operations (e.g., OCR and/or semantic search) to reduce unnecessary processor tasking and power (e.g., battery) consumption. The electronic device 101 performing the one or more first operations (e.g., OCR, and/or semantic search) which recognize the informational content, optionally includes generating a representation of the informational content detected in the first region 310a for use in subsequent processes (e.g., saving to memory, and/or generating secondary information). A representation of the informational content as disclosed herein includes, but is not limited to, visual representations (e.g., for presentation via one or more display generation components), and/or an audible representations (e.g., for presentation via one or more speakers).

In some examples, a method 400 is performed by the electronic device, as illustrated in FIG. 4B for instance, wherein in conjunction with capturing the one or more second optical captures (at 408), the electronic device optionally determines when the one or more second criteria have been satisfied (at 410). In some examples, the one or more second criteria optionally include a criterion that the one or more portions of the user occludes a first region of a first object from a viewpoint of the electronic device in the one or more second optical captures. In conjunction with determining that the one or more second criteria have been satisfied (at 410) the electronic device initiates one or more operations (at 412) on the one or more first optical captures. By initiating the one or more operations (at 412) on the first optical captures, the electronic device is able to determine the informational content indicated by the user wherein a portion (e.g., first region) of the informational content is occluded by the one or more portions of the user. The one or more operations initiated (at 412) by the electronic device optionally include processes such as, but not limited to, Optical Character Recognition (OCR), non-character recognition, graphical content searching, and/or text recognition algorithms to determine the presence of textual information. In some examples, initiating the one or more operations (at 412) includes generating a representation of the informational content within the first region indicated by the user. In some examples, in conjunction with generating a representation of the informational content, the electronic device optionally saves to memory (at 414) the generated representation of the informational content. In some examples, when the one or more second criteria are not satisfied (at 410) the electronic device optionally forgoes performing the one or more operations (at 412) and/or reverts to capturing one or more second optical captures (at 408). Additionally or alternatively, when the one or more second criteria are not satisfied, the electronic device optionally forgoes performing the one or more operations (at 412) and/or reverts to capturing and saving one or more first optical captures (at 402) and/or any portion of the process preceding determining when the one or more second criteria are satisfied (at 410).

In some examples, as illustrated in FIGS. 3B-3D for instance, after capturing the one or more second optical captures of the first object, while the one or more portions of the user satisfy the one or more second criteria, including a criterion that is satisfied when the one or more portions of the user are performing a first gesture, and before initiating the one or more first operations, the electronic device 101 initiates a mapping operation wherein one or more regions, including the first region 310a, in one or more second optical captures are matched to one or more first regions (e.g., 310a) in the one or more first optical captures. In some examples, in conjunction with the satisfying the one or more second criteria, the electronic device 101 initiates a one or more mapping operations wherein one or more locations (e.g., first region 310a, and/or one or more first points 351a-351e) from the one or more second optical captures 312 are mapped to corresponding locations in the one or more first optical captures 306. Mapping the one or more locations from the one or more second optical captures 312 to the one or more first optical captures 306 allows the electronic device 101 to determine, interpolate, and/or calculate the relative locations of items or regions of interest (e.g., first region 310a) identified in the one or more second optical captures 312, within the one or more first optical captures 306. Once the locations from the one or more second optical captures 312 are mapped to the one or more first optical captures 306, the electronic device 101 optionally performs the one or more first operations on the one or more first optical captures 306 regardless of changes in the views captured in the first optical captures and the second optical captures (e.g., due to changes in the view of the physical environment 300). In some examples, the mapping operation allows the electronic device 101 to identify informational content indicated by the user (e.g., first region 310a) within the one or more second optical captures 312 and within the one or more first optical captures 306, and optionally perform the one or more first operations on the one or more first optical captures 306. Performing a mapping between the one or more second optical captures 312 and the one or more first optical captures 306 allows the electronic device 101 to perform the one or more first operations on the one or more optical captures on areas of interest (e.g., first region 310a identified in the one or more second optical captures) in the event the electronic device 101 view is altered (e.g., perspective angle, distance from objects, zoomed in, and/or zoomed out) between the one or more first optical captures and the one or more second optical captures.

In some examples, as illustrated in FIG. 3D for instance, one or more points (e.g., 351a-351e) are optionally identified in the one or more second optical captures 312 in conjunction with the one or more second criteria have been satisfied. The one or more points (e.g., 351a-351e) are optionally randomly selected, selected based on identifiable characteristics of the object 304 or the physical environment 300, and/or predetermined relative to the field view of the electronic device 101. In some examples, at least one of the one or more points in the one or more second captures are optionally associated with the first region 310a. In some examples, one or more points (e.g., 351a-351e) are optionally identified by the user prior to satisfying the one or more second criteria. As illustrated in FIG. 3D, in conjunction with the one or more points (e.g., 351a-351e) being identified in the one second optical captures, the electronic device 101 identifies the one or more points (e.g., 352a-352e) in the one or more first optical captures. In some examples, the mapping operation includes homography.

In some examples, a method 400 is performed by the electronic device, as illustrated in FIG. 4B for instance, wherein in conjunction with capturing the one or more second optical captures (at 408), the electronic device optionally initiates one or more mapping operations (at 418) and/or references (at 419) the stored one or more first optical captures. The one or more mapping operations optionally reference 419 the stored one or more first optical captures compare the one or more second optical captures to the one or more first optical captures to match one or more locations within the one or more second optical captures to one or more corresponding locations within the one or more first optical captures. Performing the one or more mapping operations (at 418), and/or referencing (at 419) the stored one or more first optical captures allows the electronic device to focus the one or more first operations (e.g., OCR, non-character recognition, and/or graphical content searching) to a first region of the one or more first optical captures, which corresponds to the first region of the one or more second optical captures, which is occluded by the one or more portions of the user (e.g., extended finger). Performing the one or more mapping operations (at 416) further allows the electronic device to account for movements of the electronic device associated with movements of the user between the first optical captures and the second optical captures. For instance, following capturing the one or more first optical captures and saves (at 402), movement of the user at the electronic device optionally results in changes to the field of view of the electronic device. Movement of the user optionally results in changes in view angle, proximity to the object, and/or lateral tilt induced by user movements (e.g., head tilting, walking, standing up, and/or sitting down).

In some examples, as illustrated in FIG. 3D for instance, the mapping operation optionally includes, while the one or more portions of a user satisfy the one or more second criteria, determining the relative location of the of the one or more portions of a user (e.g., first hand 308a, and/or first extended finger 309a) within the one or more first optical captures 306 which correspond to the one or more portions of a user within the one or more second optical captures 312. In some examples, the mapping operation optionally includes determining the relative location of the one or more first portions (e.g., first hand 308a, and/or first extended finger 309a) of the user in the one or more first optical captures 306 which correspond to the location of the one or more portions of a user in the one or more second optical captures 312. Determining the relative location of the one or more portions of a user within the one or more first optical captures 306, which correspond to the relative location of the one or more portions of a user within the one or more second optical captures, enables the electronic device 101 to optionally perform the one or more first operations on a targeted area (e.g., the area that corresponds to the first region 310a) which is indicated and/or occluded by the one or more first portions of the user which satisfy the one or more second criteria.

In some examples, the electronic device 101 performs a mapping operation on a first hand 308a of a user, a first extended finger 309a of a user, and/or other portions of the user detected within the field of view of the electronic device 101. In some examples, the electronic device 101 performs a mapping operation on one or more first portions of the user which satisfy the one or more second criteria. Additionally or alternatively, in some examples, the electronic device 101 optionally performs a mapping operation on one or more portions of the user which satisfy the one or more first criteria and/or performs a mapping operation on the one or more portions of a user which are detected in the field of view of the electronic device 101.

In some examples, a method 400 is performed by the electronic device, as illustrated in FIG. 4B for instance, initiating one or more mapping operations (at 418) and/or referencing (at 419) the stored one or more first optical captures allows the electronic device to determine a location of the one or more portions of the user within the one or more first optical captures which correspond to a location of the one or more portions of the user within the one or more second optical captures.

In some examples, in conjunction with satisfying the one or more second criteria, the electronic device 101 initiates one or more first operations, optionally including detecting for textual information in the first region. In some examples, the electronic device 101 uses computer vision to determine when the first region 310a comprises textual information, and/or graphical information prior to initiating a subsequent first operation which optionally includes OCR and/or semantic search algorithms. In some examples, the one or more first operations are performed by the electronic device, and/or by a second electronic device 350 (e.g., phone in FIG. 3B), which is in digital communication with the electronic device.

In some examples, in conjunction with detecting textual information and/or graphical information, the electronic device 101 optionally initiates one or more second operations such as OCR and/or semantic search. In some examples, when the electronic device 101 does not detect textual information and/or graphical information within the first region 310a, the electronic device 101 optionally forgoes initiating one or more second operations such as OCR and/or semantic search. By forgoing initiating the one or more second operations, the electronic device 101 conserves processor utilization and power consumption. In some examples, the one or more second operations are performed by the electronic device, and/or by a second electronic device 350 (e.g., phone in FIG. 3B) which is in digital communication with the electronic device.

In some examples, a method 400 is performed by the electronic device, as illustrated in FIG. 4B for instance. Initiating one or more operations (at 412) optionally includes detecting for particular types of information (e.g., textual, and/or graphical) to allow the electronic device to subsequently determine when to apply one or more second operations (at 412) (e.g., OCR, and/or graphical content searching) to generate a representation of the informational content (at 412). Furthermore, when the electronic device determines through one or more first operations (at 412) that a type of informational content (e.g., textual information) is not present within a first region, the electronic device optionally forgoes performing one or more second operations (e.g., OCR) related to that type of informational content.

In some examples, in accordance with a determination that the first region of the one or more first optical captures contains textual information occluded by the one or more portions of the user, the electronic device 101 optionally performs one or more second operations on the first optical captures to generate a representation of the textual information in the first region occluded by the one or more portions of the user.

In some examples, as illustrated in FIG. 3E for instance, following a determination that the one or more second criteria are satisfied, including a criterion that the one or more portions of the user includes a first hand 308a performing a first gesture occluding (e.g., first extended finger 309a indicating, and/or pointing to) the first region 310a of the object 304, and following performing the one or more second operations on the one or more first optical captures 306 including the first region 310a, displaying, via the one or more displays 120, a first user interface element 318a including the representation of the textual information in the first region 310a occluded by first gestures performed by the one or more portions of the user. In some examples, in conjunction with the one or more second criteria being satisfied, including a criterion that one or more portions of a user occludes a first region 310a, the electronic device 101 optionally initiates one or more second operations on the one or more first optical captures 306, including the first region 310a, to generate a representation of the informational content (e.g., textual information, and/or graphical information) within the first region 310a. For instance, as illustrated in FIG. 3E, the user's first extended finger 309a occludes the first region 310a which includes the word “Renaissance,” thus satisfying the one or more second criteria, including a criterion that one or more portions of a user occludes the first region of the object 304. Accordingly, the electronic device 101 initiates one or more second operations on the first optical captures 306 and generates a representation of the occluded informational content (“Renaissance”) and displays, via the one or more displays 120, a first user interface element 318a including the generated representation of the occluded informational content (e.g., textual information). Additionally or alternatively, the electronic device optionally presents the generated representation of the occluded informational content in an audible format, played via one or more speakers at the electronic device or at a second electronic (e.g., second electronic device 350, such as a phone, in FIG. 3B) in digital communication with the electronic device. In some examples, a visual representation of the occluded information content is presented via the one or more displays (e.g., touch screen) 354 of the second electronic device 350.

Furthermore, the representation of the one or more target words includes representing the one or more target words with a graphical representation. For instance, a generated representation of the word “yellow” optionally includes a visual representation of the color yellow, or a generated representation of the word “giraffe” optionally includes an image of a giraffe.

While examples shown herein relate to the use of an extended index finger (e.g., 309a) of a user's first hand 308a in an extended position as a gesture performed by the first hand 308a, alternate examples wherein the one or more second criteria include a criterion that is satisfied when a thumb, middle finger, ring finger, pinkie finger, or combination thereof are in an extended position, are within the spirit and scope of the present disclosure. Furthermore, in some examples, the user optionally programs the electronic device 101 to recognize a custom gesture such as in the event the user is unable to perform one or more predetermined gestures.

Generating a representation of the informational content (e.g., textual information, and/or graphical information) within the first region 310a, allows the electronic device 101 to perform subsequent operations related to the informational content such as, but not limited to, generating and/or displaying a definition, an image, an encyclopedic entry, and/or Artificial Intelligence (AI) generated content related to the generated representation. Furthermore, the generated representation allows the electronic device 101 to optionally save the representation of one or more target words to memory 220 of the electronic device. In some examples, in conjunction with initiating image processing (e.g., OCR), the electronic device 101 saves the informational content (e.g., textual information, and/or graphical information) such as found in the within the first region (e.g., 310a) to memory 220 (e.g., in FIG. 2A-FIG. 2B), such as short-term memory storage (e.g., copy indicated at 320). The user is able to export (e.g., paste) the generated representation of the informational content into alternate applications/files on the electronic device 101, or into applications/files on alternate electronic devices. In some examples, in conjunction with saving informational content within the first region 310a, the electronic device 101 optionally indicates a confirmation of saving through a notification (e.g., audible notification 321) which is optionally played through one or more speakers 216 (at FIG. 2A-FIG. 2B).

In some examples, as illustrated in FIGS. 3E-3F for instance, wherein the first region 310a comprises textual information, the first user interface element (e.g., 318a, and/or 318b) optionally includes a definition related to the textual information. In some examples, as illustrated in FIGS. 3E-3F for instance, the first user interface element (e.g., 318a, and/or 318b) optionally includes a definition of the textual information (e.g., one or more words) identified in the first region 310a. The definition as discussed herein can be optionally retrieved and/or formulated from a published dictionary, crowd-sourced dictionary, and/or through Artificial Intelligence (AI) algorithms. In some examples, the electronic device 101 optionally displays informational content (e.g., definition of one or more target words, encyclopedic entry, and/or graphical representation) in a first user interface element (e.g., 318a, and/or 318b) with informational content related to a first region (e.g., 310a) of the physical environment 300 following the one or more portions of the user satisfying the one or more second criteria. In some examples, the encyclopedic entry presented in the first user interface element includes an image related to the one or more target words of the textual information.

In some examples, the electronic device optionally determines a geographic location of the electronic device, and displays, via the one or more displays a definition associated with the textual information that is formulated based on the geographic location of the electronic device. In some examples, following the determination that the one or more portions of the user (e.g., first hand 308a) satisfy one or more second criteria, the electronic device 101 subsequently, or concurrently, detects the geographic location of the electronic device 101, and displays a definition of the textual information that is formulated based on the geographic location of the electronic device 101. In some examples, the geographic location of the electronic device is determined using one or more location sensors 204 (e.g., GPS sensors). Alternatively or additionally, the location of the electronic device 101 is optionally determined using communication circuitry 222 (e.g., Bluetooth®, and/or Wi-Fi®), location information associated with a local or extended network, and/or crowd-sourced location information.

In some examples, as illustrated in FIG. 3G for instance, in conjunction with the initiating image processing (e.g., semantic search), the electronic device 101 saves the informational content (e.g., textual information, and/or graphical information) such as found in the within the first region (e.g., 310a) to memory 220 (e.g., in FIG. 2A-Fig. 2B), such as short-term memory storage (e.g., copy indicated at 320). The user is able to export (e.g., paste) the generated representation of the informational content into alternate applications/files on the electronic device 101, or into applications/files on alternate electronic devices. For instance, as illustrated in FIG. 3G, the one or more portions of a user (e.g., first hand 308a) of the user indicates the second region 310b which includes the “Museum” logo. Upon satisfying the one or more second criteria, the electronic device 101 optionally performs one or more operations on the first optical captures to generate a representation of the occluded logo, and optionally saves the generated representation of the logo in the second region 310b to memory. In some examples, in conjunction with saving informational content within the first region 310a, the electronic device 101 optionally indicates a confirmation of saving through a notification (e.g., audible notification 321) which is optionally played through one or more speakers 216 (at FIG. 2A-FIG. 2B).

In some examples, a method 400 is performed by the electronic device, as illustrated in FIG. 4B for instance, which includes determining when the one or more second criteria are satisfied (at 410), including a criterion that is satisfied when a first hand of a user is detected performing a gesture, such as an extended index finger.

In some examples, as illustrated in FIG. 3H for instance, the one or more second criteria include a criterion that is satisfied when the one or more portions of a user include a first hand 308a performing a first gesture (e.g., first extended finger 309a), and a second hand 308b different than the first hand, performing a second gesture (e.g., second extended finger 309b), wherein the first gesture and the second gesture are associated with and/or indicate a third region 310c of the physical environment. For instance, as illustrated in FIG. 3H, a first extended finger 309a of a first had of the user, and a second extended finger 309b of the second hand of the user are detected as being associated with a third region 310c containing a string of textual information (e.g., “The Mona Lisa is a portrait”) wherein the first extended finger 309a occludes a portion of the first region (e.g., “portrait”), thus satisfying the one or more second criteria. In conjunction with determining that the one or more second criteria are satisfied, the electronic device 101 optionally initiates one or more operations on the one or more first optical captures 306, and generates a representation of the string of text, including the occluded informational content (e.g., “portrait”), and saves the string of text (e.g., “The Mona Lisa is a portrait”) to memory 220 (at FIG. 2A-FIG. 2B).

In some examples, initiating one or more operations optionally includes a context searching process to identify contextually related content such as the relationship between two related words (e.g., “Mona,” and “Lisa”), textual content within one or more sentences, and/or textual content within one or more paragraphs.

In some examples, a method 400 is performed by the electronic device, as illustrated in FIG. 4B for instance, which determines when the one or more first criteria are satisfied (at 406). The one or more first criteria optionally includes a criterion that is satisfied when a user's first hand is detected, and a user's second hand is detected to be associated with an object, region of a first object, or region of the physical environment. In some examples, determining when the one or more first criteria are satisfied (at 406) includes a criterion that is satisfied when a user's first hand is detected performing a first gesture (e.g., extended index finger), and a user's second hand is detected performing a second gesture (e.g., extended index finger). In some examples, following satisfying the one or more first criteria, the electronic device determines that the one or more second criteria are satisfied (at 410) when a portion of the first hand and/or the second hand of the user occlude a region of the first object.

In some examples, in the event that the electronic device 101 detects the movement of one or more portions of the user within the field of view of the electronic device 101 and/or directed to an object or region of the physical environment, the electronic device 101 optionally forgoes initiating the one or more operations on the first optical captures. In some examples, the one or more first criteria and/or second criteria include a criterion that is satisfied when the one or more portions of a user (e.g., user's first hand 308a, and/or user's second hand 308b) are static, and/or detected as moving below a threshold amount of movement (e.g., maximum threshold of velocity, and/or maximum threshold of acceleration) velocity for a predetermined time period, thereby indicating a user's attention is directed to an object, or region of interest within the physical environment.

Examples of a predetermined time period include: less than 50 milliseconds, 50 milliseconds, 150 milliseconds, 0.5 seconds, 1 second, etc. Examples of a velocity threshold include virtual velocity based thresholds (e.g., 0 pixels/s, Z1 pixel/s, 5 pixels/s, 10 pixels/s, 25 pixels/s, 50 pixels/s, 100 pixels/s, or more than 100 pixels/s) and/or real-world based velocities (e.g., physical velocities) including, but are not limited to, velocities of: 0 mm/s, 1 mm/s, 5 mm/s, 25 mm/s, 100 mm/s, 50 cm/s, 1 m/s, 3 m/s, or more than 3 m/s, etc. Examples of an acceleration threshold include virtual distance based accelerations (e.g., 0 pixels/s^2, 1 pixel/s^2, 5 pixels/s^2, 10 pixels/s^2, 25 pixels/s^2, 50 pixels/s^2, 100 pixels/s^2, or more than 100 pixels/s^2) and/or real-world based accelerations (e.g., physical velocities) including, but are not limited to, distances of: 0 mm/s^2, 1 mm/s^2, 5 mm/s^2, 25 mm/s^2, 100 mm/s^2, 50 cm/s^2, 1 m/s^2, 3 m/s^2, or more than 3 m/s^2, etc.

In some examples, when the electronic device 101 detects that the one or more portions of a user are moving and/or above a threshold velocity, and the one or more portions of a user are subsequently moving below a threshold velocity for a threshold period of time, thereby indicating a user's attention is directed to an object, or region of interest within the physical environment, the electronic device initiates one or more operations on the one or more first optical captures 306.

In some examples, as illustrated in FIG. 3H for instance, the one or more second criteria include a criterion that the first portion of the user (e.g., first hand 308a, and/or first extended finger 309a) and the second portion of the user (e.g., second hand 308b, and/or second extended finger 309b) are detected as associated (e.g., aligned) with a string of textual information. In some examples, in accordance with a determination that the first extended finger 309a and the second extended finger 309b are associated (e.g., aligned) with a string of textual information (e.g., text on a single line) within the indicated third region 310c when the one or more second criteria are satisfied, the electronic device 101 saves the string of textual information to memory 220 (at FIG. 2A-FOG. 2B). In some examples, saving the textual information to memory includes the electronic device 101 identifying the string of textual information between the first extended finger and the second extended finger, including a portion of the third region 310c occluded by the one or more portions of the user (e.g., “portrait”). Furthermore, in some examples, saving the string of textual information identified in the third region 310c optionally includes initiating the one or more operations on the one or more first optical captures to generate a representation of the string of textual information prior to saving the representation of the string of textual information to the memory.

A string of textual information, as discussed herein, includes one or more characters of text. Furthermore, a string of textual information of some examples optionally includes a plurality of concatenated characters forming a word, multiple words, a phrase, and/or at least part of one or more sentences. A string of textual information, in some examples, optionally includes textual information which is presented horizontally and reads left to right (e.g., English), reads right to left (e.g., Arabic), reads top to bottom (e.g., Japanese), and/or or bottom to top (e.g., Batak). Further still, in some examples, a string of textual information optionally reads in a direction which is in contrast with common practice (e.g., stylized text which reads diagonally).

In some examples, a method 400 is performed by the electronic device, as illustrated in FIG. 4B for instance, which includes determining when the one or more second criteria are satisfied (at 410), and includes determining when a first portion of a user (e.g., first extended finger) and a second portion of the user (e.g., second hand) are associated with (e.g., aligned with) a string of textual information.

In some examples, as illustrated in FIG. 3I for instance, in accordance with a determination that the user's first extended finger 309a and the user's second extended finger 309b are associated with multiple lines of textual information within the fourth region 310d of the first object when the one or more second criteria are satisfied, the electronic device 101 saves the representation of the textual information to memory.

In some examples, the electronic device 101 optionally determines that a first portion of a user (e.g., first hand 308a, and/or first extended finger 309a) and a second portion of a user (e.g., second hand 308b, and/or second extended finger 309b) are associated with multiple lines of textual information when the first portion of the user is associated with a first line 311a of textual information, and the second portion of the user is associated with a second line 311b of textual information, different than the first line of textual information, wherein the first line 311a of textual information and the second line 311b of textual information are optionally within a fourth region 310d of an object 304 within the physical environment 300. In some examples, as illustrated in FIG. 3I for instance, when the first extended finger 309a and the second extended finger 309b are respectively associated with a first line 311a of textual information and a second line 311b of textual information respectively, the electronic device 101 detects the first line 311a, the second line 311b, and all intervening lines, as being within the fourth region 310d.

In some examples, saving the representation of the textual information to memory includes identifying the multiple lines (e.g., first line 311a, and second line 311b) of textual information based on a position of the first extended finger in relation to a position of the second extended finger, including the portion of the first region occluded by the one or more portions of the user (e.g., “time” occluded by the first extended finger 309a, and/or “The” occluded by the second extended finger 309b). In some examples, the electronic device 101 determines the informational content (e.g., textual information) within the first region based on the contextual indications (e.g., paragraph form, sentence form, line spacing, and/or line indentation). For instance, as illustrated in FIG. 3I, a first extended finger 309a of the user indicates a bottom right corner of a paragraph while occluding the word “time” and the second extended finger indicates a top left corner of a paragraph while occluding the word “The.” In some examples, in response to detecting the first extended finger 309a and the second extended finger 309b indicating a fourth region 310d, wherein at least one or more portions of a user occlude informational content, the electronic device 101 optionally performs a context searching operation to determine contextual indications of the informational content within the third region 310c. For instance, context searching in the example as illustrated in FIG. 3I indicates that the occluded word “The” is the beginning of a sentence and the beginning of a paragraph, and that “time” is the end of a sentence beginning with “Considered” and the end of the paragraph which includes the first occluded word “The.” Accordingly, the electronic device 101 optionally determines that the first region 310d of the object 304 includes the paragraph beginning with the occluded word “The” and ends with the occluded word “time,” optionally generates a representation of the paragraph, and optionally saves the representation of the paragraph to memory 220.

In some examples, as illustrated in FIG. 3I for instance, in accordance with a determination that the first extended finger 309a and the second extended finger 309b are associated with multiple lines of textual information (e.g., first line 311a, and second line 311b) associated with the object 304 when the one or more second criteria are satisfied, the electronic device 101 initiates one or more operations on the one or more first optical captures to recognize and/or generate a representation of the textual information within the fourth region 310d indicated by the extended fingers of the user. In some examples, shown in FIG. 3I for instance, in conjunction with determining that a first portion of a user (e.g., first hand 308a, and/or first extended finger 309a) and a second portion of a user (e.g., second hand 308b, and/or second extended finger 309b) satisfy the one or more second criteria, the electronic device 101 optionally determines when the first portion of the user and the second portion of the user are associated with multiple lines of textual information.

Alternatively or additionally, in some examples, as illustrated in FIG. 3J for instance, in accordance with a determination that the first extended finger and the second extended finger are associated with one or more graphical elements associated with the fifth region 310e of the first object when the one or more second criteria are satisfied, the electronic device 101 performs one or more operations on the first region 310 (e.g., sematic search) to generate a representation of the graphical information, and saves the representation of the graphical information to memory, such as short-term memory storage (e.g., copy indicated at 320), wherein the user is able to export (e.g., paste) the generated representation of the informational content into alternate applications/files on the electronic device 101, or into applications/files on alternate electronic devices. For instance, as illustrated in FIG. 3J, the first extended finger 309a and the second extended finger 309b of the user indicate the fifth region 310e which includes the “Museum” logo. Upon satisfying the one or more second criteria, the electronic device 101 optionally performs one or more operations on the first optical captures 306 to generate a representation of the occluded logo within fifth region 310e, and optionally saves the generated representation of the logo to memory.

In some examples, as illustrated in FIG. 4B for instance, a method 400 is performed by the electronic device which determines when the one or more second criteria are satisfied (at 410). Determining when the one or more second criteria are satisfied includes determining when a first portion of a user (e.g., first extended finger) and a second portion of the user (e.g., second extended finger) are associated with multiple lines of textual information.

In some examples, as illustrated in FIG. 3K for instance, the electronic device establishes a first vertical boundary line 340a originating from the first extended finger that intersects a first horizontal boundary line 340b originating from the second extended finger, and establishes a second vertical boundary line 340c originating from the second extended finger that intersects a second horizontal boundary line 340d originating from the first extended finger, wherein the sixth region 310f of textual information corresponds to textual information included within an area designated by the intersection of the first vertical boundary line 340a, the first horizontal boundary line 340b, the second vertical boundary line 340c, and the second horizontal boundary line 340d.

In some examples, as illustrated in FIG. 3K for instance, the electronic device 101 optionally identifies the fourth region 310d by establishing boundary lines (e.g., 340a-340d) in association with the first portion of the user (e.g., first extended finger 309a) and the second portion of the user (e.g., second extended finger 309b). For instance, in some examples, the electronic device 101 optionally detects the first extended finger 309a and establishes a first vertical boundary line 340a originating from the first extended finger 309a, wherein the first vertical boundary line 340a intersects a first horizontal boundary line 340b originating from the second extended finger 109b. Furthermore, the electronic device 101 optionally establishes a second vertical boundary line 340c originating from the second extended finger 309b, wherein the second vertical boundary line 340c intersects a second horizontal boundary line 340d originating from the first extended finger 309a. The intersection of the boundary lines 340a-340d optionally results in a rectangular shaped fourth region 310d designating the multiple lines of textual information with which the first extended finger 309a and the second extended finger 309b are associated.

In some examples, as illustrated in FIG. 3K for instance, after meeting the one or more second criteria, and in conjunction with initiating one or more operations on the one or more first optical captures, in accordance with a determination that one or more of the boundary lines (e.g., 340a-340d) intersect (e.g., transect) textual information, the electronic device 101 optionally offsets the one or more boundary lines which intersect the textual information. For instance, as illustrated in FIG. 3K, the first vertical boundary line 340 intersects textual information (e.g., multiple words on multiple lines of textual information). Accordingly, the electronic device optionally incrementally offsets the first vertical boundary line 340a away from the second vertical boundary line 340c until the first vertical boundary line no longer intersects textual information such as illustrated in FIG. 3I. For further illustrative purposes, as illustrated in FIG. 3K, the second horizontal boundary line 340d transects textual information (e.g., multiple words on a single line of textual information). Accordingly, the electronic device optionally incrementally offsets the second horizontal boundary line 340d away from the first horizontal boundary line 340b until the first vertical boundary line no longer intersects textual information, such as illustrated in FIG. 3I.

In some examples, upon detection of a boundary line (e.g., 340a-340d) which transects textual information, the electronic device 101 optionally offsets the boundary line by increments of: 0 pixels, 1 pixel, 5 pixels, 10 pixels, 25 pixels, 50 pixels, 100 pixels, and/or more than 100 pixels. Alternatively or additionally, the device optionally offsets the boundary line by increments of: 0.1 mm, 0.5 mm, 1 mm, 5 mm, 1 cm, etc.

In some examples, in conjunction with the identification of the fourth region 310d of the object 304 containing multiple lines of textual information, the electronic device 101 optionally initiates one or more operations to generate a representation of the multiple lines of textual information designated within the fourth region 310d. In some examples, subsequent to generating the representation of the multiple lines of textual information, the electronic device 101 optionally displays, via the one or more displays 120, the representation of the multiple lines of textual information. Furthermore, in some examples, the electronic device 101 saves (e.g., actively, or passively) the representation of the multiple lines of textual information to memory 220.

In some examples, a method 400 is performed by the electronic device, as illustrated in FIG. 4B for instance, which includes identifying a region (at 416) including establishing a boundary designating a region within which the electronic device performs one or more operations (at 412) to detect, recognize, and/or generate a representation of informational content therein.

In some examples, the electronic device is configured to capture one or more second optical captures of an object of interest which includes visual information which is potentially an object of interest to the user. For instance, when the electronic device detects via the one or more first optical captures, referencing FIG. 3B, that a first object of interest (e.g., a Quick-Response (QR) code 303, Uniform Resource Locator (URL), etc.) is within the physical environment of the user, and the electronic device determines that the attention of the user is directed to (e.g., gaze, hand movement, hand gesture, etc.) and/or the attention of the user increases toward the object of interest, electronic device optionally captures second optical captures of the first object of interest. In some examples, after capturing the one or more first optical captures, and the one or more portions of the user are detected as occluding the first object of interest (e.g., QR code), the electronic device optionally saves the first optical capture of the object of interest for subsequent use by the user. For instance, when the electronic device determines that the first one or more optical captures include a QR code, the electronic device optionally captures one or more first optical captures of the QR code, when the first hand of the user is detected as occluding the QR code in the one or more second optical captures, the electronic device optionally saves the QR code to memory. In some examples, when the electronic device detects an object of interest (e.g., QR code) in the one or more first optical captures, the electronic device saves the first optical capture of the object of interest to memory without requiring the attention of the user to be directed to the object of interest, and/without capturing one or more second optical captures of the object of interest. Upon saving the one or more optical captures (e.g., first optical captures, and/or second optical captures) of the object of interest, the electronic device optionally presents a notification (e.g., visual, audible, haptic, etc.) to the user that one or more optical captures indicating that an object of interest has been captured and saved. When the object of interest includes visual information corresponding to a link (e.g., URL, QR link, etc.), the electronic device optionally retrieves the information from the link and displays the information associated with the object of interest without action required from the user. Additionally or alternatively, in some examples, the electronic device presents notification to the user that one or more optical captures comprising the link to the object of interest is cached, such that the link is available for the user to selectively click and/or activate.

In some examples, when the electronic device determines that the object of interest contains visual information (e.g., textual information, and/or graphical information), the electronic device performs one or more operations (e.g., OCR) on the one or more optical captures (e.g., first optical captures and/or second optical captures) to save the visual information to memory for later use by the user, or for use in a subsequent operation. For instance, when the electronic device determines that an art exhibit flyer which corresponds to an object of interest includes dates, the electronic device optionally saves the dates to allow the user to create a calendar event corresponding to the art exhibit.

In some examples, when the electronic device detects an object of interest, and the electronic device determines that the object of interest includes visual information related to the object of interest (e.g., optical capture, link, and/or schedule information), the electronic device communicates the visual information (e.g., via the second optical captures) to a connected electronic device (e.g., smart phone) which is communicatively connected with the electronic device. For instance, when the electronic device detects an object of interest which includes information (e.g., schedule information, link, QR code, etc.) the electronic device optionally communicates the information to the connected electronic device, such that the user optionally interacts with the visual information (e.g., clicks a link, views an associated document (e.g., restaurant menu from QR link), saves schedule information to calendar, etc.). In some examples, the electronic device captures one or more second optical captures of one or more objects of interest according to a predetermined time-period (e.g., every 10 second, every 30 second, every 2 minutes, etc.), and performs the one or more operations (e.g., OCR, graphical content recognition, etc.) in accordance with the predetermined time period, a second predetermined time period, and/or upon detection of visual information associated an object of interest. By capturing the visual information and allowing the user to optionally interact with the visual information at a subsequent time, the electronic device allows the user to selectively interact with and use the information associated with identified objects of interest without requiring the user's immediate attention. Furthermore, by caching and allowing the user to interact with visual information subsequent to the detection of the object of interest, the electronic device protects the user's privacy as related to visiting a URL which is configured to track their habits and/or activities (e.g., by tracking the user's user of a QR link associated with a piece of art while visiting a particular museum).

In some examples, a method 400 is performed by the electronic device, as illustrated in FIG. 4B for instance, which includes, in response to capturing and saving the one or more first optical captures (at 402), the electronic device optionally initiates one or more operations (at 412) on the one or more first optical captures. By initiating one or more operations (at 412) in response to capturing and saving the one or more first optical captures (at 402), the electronic device optionally identifies one or more objects of interest and caches (at 414) representations of informational content generated from the one or more first optical captures to reduce operational latency and increase the response rate of electronic device in response to user inputs. For instance, after the representation of the informational content is saved, when the attention of the user is directed to one or more of the one or more objects of interest, the electronic device optionally presents (e.g., displays via one or more displays, and/or plays via one or more speakers) the representation of the informational content.

In some examples, after and/or while the one or more second criteria are satisfied, the electronic device detects, via the one or more input devices, a first user input indicating a command to save the representation of textual information to memory. When the electronic device 101 detects a second user input indicating a command other than a command to save the representation of textual information to memory within a threshold amount of time of detecting the first user input, the electronic device 101 forgoes saving the representation of textual information to the memory. For instance, when an electronic device 101 detects that the user has provided an input to save (e.g., copy) the representation of textual information, but receives an additional input which indicates a second input (e.g., delete, display, and/or modify) which is unrelated to or contradicts the first input to save, the electronic device 101 forgoes saving the representation of the textual information. In some examples, the electronic device 101 optionally forgoes saving the representation of textual information when a second input is received within a threshold period of time from the first input.

In some examples, after and/or while the one or more second criteria are satisfied, in accordance with a determination that the first region of the one or more first optical captures 306 contains graphical information, the electronic device 101 performs one or more second operations (e.g., graphical content searching) on the one or more first optical captures 306 to generate a representation of the graphical information in the first region occluded by the one or more portions of the user in the one or more second optical captures. For instance, as illustrated in FIG. 3J, when the one or more second criteria are satisfied by the first extended finger 309a and the second extended finger 309b of the user, and the second region 310b indicated by the extended fingers is detected to include graphical content, the electronic device 101 performs one or more second operations (e.g., graphical content searching, and/or graphical content recognition) to optionally determine and/or generate a graphical representation of the “Museum” logo included within the first region.

In some examples, the electronic device captures the one or more optical captures (e.g., first optical captures 306, and/or second optical captures 312) within a predetermined time period. Examples of a predetermined period of time include: less than 0.1 seconds, 0.1 seconds, 0.2 seconds, 0.5 seconds, 1 second, 2 seconds, 5 seconds, and/or longer than 5 seconds.

In some examples, in response to capturing the one or more first optical captures 306, the electronic device 101 performs one or more operations (e.g., OCR, graphical content searching, and/or contextual searching) on the one or more first optical captures 306. In some examples, the electronic device 101 performs one or more operations on the one or more first optical captures 306 prior to satisfying one or more first criteria and/or one or more second criteria. For instance, capturing the one or more first optical captures 306 optionally triggers the electronic device 101 to optionally perform an OCR operation to determine textual information, and/or optionally performs a graphical content recognition operation to determine graphical information within the one or more first optical captures 306. Furthermore, the one or more operations optionally include processes to generate a representation of informational content (e.g., textual information, and/or graphical information) prior to satisfying the one or more first criteria and/or the one or more second criteria. Performing operations on the one or more first optical captures 306 prior to satisfying the one or more first criteria and/or the one or more second criteria allows the electronic device to cache representation(s) of informational content and results in reduced operational latency for the display and/or other operations (e.g., saving) of the informational content upon satisfying the one or more first criteria and/or the one or more second criteria.

In some examples, a method 400 is performed by the electronic device, as illustrated in FIG. 4B for instance, which optionally includes, in response to capturing the one or more first optical captures and saving (at 402), the electronic device initiating one or more operations (at 412) on the one or more first optical captures. By initiating one or more operations (at 412) in response to capturing and saving the one or more first optical captures (at 402), the electronic device optionally caches (at 414) representations of informational content generated from the one or more first optical captures to reduce operational latency and increase the response rate of electronic device in response to user inputs.

In some examples, in response to a determination that the one or more second criteria are satisfied, the electronic device 101 optionally plays an audible response, via one or more speakers, indicating that the one or more second criteria have been satisfied. In some examples, the electronic device 101 optionally plays an audible notification 321 (e.g., audible tone) to indicate to a user that the one or more second criteria have been satisfied. In some examples, as illustrated in FIG. 3C, and FIGS. 3E-3G for instance, when the electronic device 101 detects a first extended finger 309a of a first hand of a user associated with a first region (e.g., 310a, and/or 310b) wherein the first extended finger 309a occludes a portion of the first region, the electronic device 101 plays an audible response (e.g., audible notification 321). Alternatively or additionally, in some examples, as illustrated in FIG. 3H-3K for instance, when the electronic device 101 detects a first extended finger 309a of a first hand of a user and a second extended finger 309b of a second hand of a user, wherein at least one of the extended fingers occludes the first region, the electronic device 101 plays an audible response (e.g., audible notification 321).

In some examples, a method 400 is performed by the electronic device, as illustrated in FIG. 4B for instance, which includes, when the one or more second criteria are satisfied (at 410), playing an audible response and/or haptic response to indicate to a user that the one or more second criteria have been satisfied. Additionally or alternatively, the electronic device optionally plays an audible response in conjunction with any alternative step (at 402-418) related to the method 400.

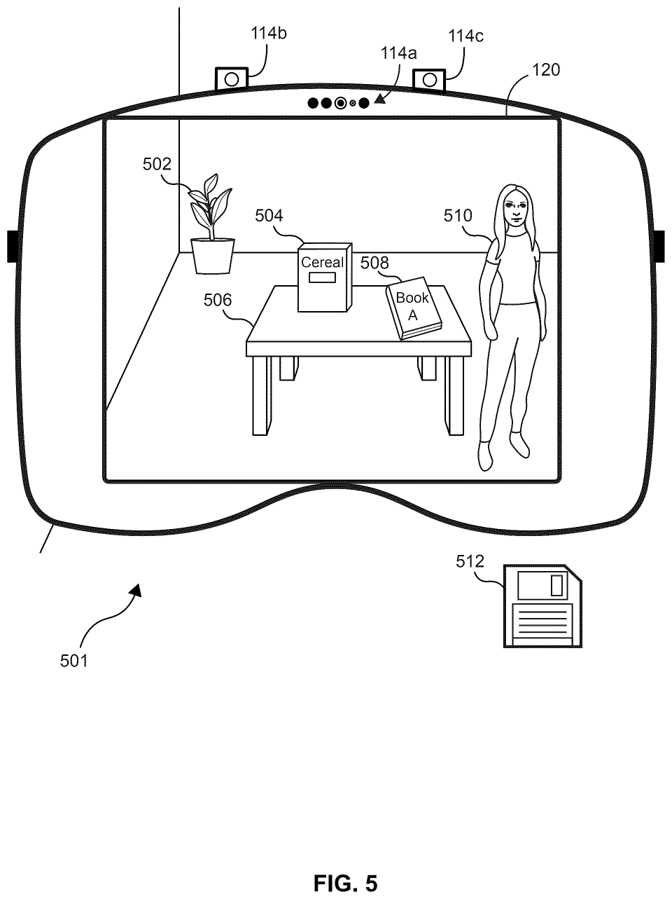

Attention is now directed to additional or alternative interactions with one or more physical objects that are presented in a three-dimensional environment at an electronic device (e.g., corresponding to electronic devices 201 and/or 260). In some examples, it may be desired to use one or more operations related to method 400 to capture and cache (e.g., save to memory) information about one or more physical objects prior to receiving input from the user corresponding to an indication to perform one or more operations. Through predictive operations, an electronic device is able to detect one or more objects, and predetermine the information that the user is likely to request pertaining to the one or more objects, generate the information, and save the information to more quickly present information (e.g., display and/or present audibly) to the user once requested, which reduces the number of inputs and/or time required to perform such operations, thereby reducing energy usage by the device. Examples of such operations are described below with reference to FIG. 5.

FIG. 5 illustrates an electronic device 501 presenting a three-dimensional environment according to some examples of the disclosure. The electronic device optionally captures one or more optical captures of the physical environment of the electronic device 501. In some examples, capturing one or more first optical captures shares one or more characteristics with capturing one or more first optical captures and/or capturing one or more second optical captures as described in relation to method 400. For example, the physical environment of the electronic device 501 includes a plant 502, table 605, box of cereal 504, book 508, and person 510. The electronic device 501 optionally predicts one or more interactions with one or more of these objects, such as a request for informational content corresponding to one or more of these objects, and obtains informational content about one or more objects without receiving a user input corresponding to a request for the informational content based on the prediction, as described in further detail below. Later, in response to receiving an input requesting informational content that is already cached, the electronic device 501 obtains the informational content from the cache and presents the informational content according to one or more examples described above with reference to FIGS. 3A-3K, for example. In some examples, predicting interactions in relation to one or more physical objects optionally shares one or more characteristics with the interactions, gestures, and/or attention of the user corresponding to one or more physical objects as described in relation to FIG. 4. By referencing previously cached informational content and using predictive actions to enable presentation of information content associated optical captures of the physical environment, the electronic device avoids the capturing of additional optical captures, thus reducing processor tasking and power consumptions, results in a faster response upon a request for information.

In some examples, the electronic device 501 predicts interactions which a user may make in relation to the one or more physical objects for the purposes of obtaining the relevant informational content corresponding with the interaction and the object, and stores the informational content using memory 512 (e.g., one or more memories 220A and/or 220B in FIG. 2A-FIG. 2B). In some examples, the electronic device 501 uses a plurality of factors to predict about which objects the user will request informational content. Based on these predictions, for example, the electronic device 501 may determine a prioritization for obtaining informational content about various objects, including a prioritization order in which to obtain informational content about the objects, prioritization of whether or not to store informational content about various objects, and/or prioritization of space in memory 512 to use for informational content about various objects. Examples of factors the electronic device 501 uses to make these predictions and determine prioritization are described in more details below.

In some examples, the electronic device 501 constructs a heatmap modeling the relative prioritization of informational content corresponding to various objects in the physical environment. Objects with higher priority and/or having more informational content inquiries with relatively high priority are optionally “hotter” on the heatmap than objects with lower priority and/or having fewer informational content inquiries with relatively high priority. In some examples, the heatmap is based on one or more of the factors for determining prioritization below. In some examples, the electronic device constructs the heatmap using artificial intelligence (AI) and/or machine learning (ML) techniques including semantic understanding.

In some examples, the prioritization is based on prior queries by the user about objects in the environment, queries made by other users about objects in the environment, and/or queries about objects similar to objects in the environment. For example, objects similar to objects in the environment include different objects of the same category, such as other plants, other food items, other furniture, other people, other books.

In some examples, the electronic device 501 predicts which objects the user will request information based on previous activity and/or interests of the user, and the relevance of the objects to that activity and/or interest. For instance, the electronic device has detected, via the one or more location sensors 204 (shown in FIG. 2A-FIG. 2B), that the user frequents the local botanical gardens. The electronic device optionally predicts that the user will inquire about the species of plant and obtains the informational content corresponding to the plant 502 (e.g., species, common name, Latin name, climate suitability, expected size, etc.). In accordance with this determination, the electronic device 501 optionally increases the prioritization of storing the informational content related to the plant 502 to memory 512.

As a further example, the electronic device 501 predicts which objects the user will request information based on the current time. For example, the electronic device detects that the current time at the electronic device is concurrent with a window of time during which the user eats breakfast. In accordance with this determination, the electronic device optionally increases the prioritization of storing the nutritional data corresponding to the cereal 504 to memory 512.

As a further example, the electronic device 501 predicts which objects the user will request information based on gaze of the user. For example, the electronic device detects the user's gaze hesitate and/or hover in a direction corresponding to the table 506. In accordance with this determination, the electronic device optionally increases prioritization of storing in memory 512 informational content relating to the table 506.

In some examples, the electronic device 501 predicts the particular inquiries the user may make about various objects in the physical environment based on one or more of the factors above and/or other factors. For example, if the electronic device 501 stores information that the user has the book 508 on a list of books to read in the future, the electronic device 501 may predict that the user will request bibliographical information about the book 508. As another example, if the electronic device 501 stores information that the user has already read the book 508, the electronic device 501 may predict that the user will request to display a user interface for writing and/or reading reviews of the book 508.

In some examples, the electronic device 501 stores informational content related to multiple inquiries about a respective object in the environment of the electronic device 501 prior to receiving an input requesting presentation of the informational content. For example, the electronic device 501 stores in memory 512 the name of person 510 and contact information for the person 510 in memory 512 based on one or more the factors. In this example, the electronic device 501 optionally obtains the name and/or phone number of the person from a contacts list of the user of the electronic device 501. While this information about the person 510 is stored in memory 512, in response to receiving a request for the name of the person, the electronic device 501 obtains the name of the person from memory 512 and presents the name of the person, for example, As another example, while this information about the person 510 is stored in memory 512, in response to receiving a request for the phone number of the person, the electronic device 501 obtains the phone number of the person from memory 512 and presents the name of the person.

In some examples, the electronic device 501 re-evaluates prioritization in response to receiving one or more requests for informational content about one or more objects in the physical environment. For example, the electronic device 501 increases the amount of space in memory 512 for storing informational content when the electronic device 501 predicts the user will request in response to receiving a request for informational content about one of the objects in the environment, compared to the amount of space allocated prior to receiving the request. In some examples, receiving a request for informational content about a first object causes the electronic device 501 to increase the amount of space in memory 512 allocated for informational content for the first object and for one or more other objects as well. Additionally or alternatively, the electronic device 501 stores additional informational content related to an inquiry made by the user that is related to, but different from, the inquiry made by the user. For example, in response to receiving a request for a style name of table 506, the electronic device 501 presents the style name of the table 506 and additionally obtains and stores other information about the table 506, such as the brand of the table 506 and/or purchasing information for the table 506. As another example, in response to receiving a request for purchasing information for the table 506, the electronic device 501 presents the purchasing information for the table and obtains and stores purchasing information for chairs that match the table 506 from the same retailer.

In some examples, the electronic device 501 obtains the informational content about the objects using a network connection (e.g., from the internet), such as performing an internet search and/or obtaining data associated with a user account of the electronic device 501 from cloud storage. In some examples, the electronic device 501 obtains the informational content from and/or using one or more applications on the electronic device 501. For example, the information may be stored in a portion of memory 512 that takes more time access than the cache and caching the information in accordance with a prioritization of that information includes moving and/or copying that information to the cache of memory 512.

In some examples, the informational content corresponding to the object is human-generated content. For example, bibliographic data related to book 508 includes information from a book archive presented in the format of the archive. In some examples, the information content corresponding to the object is generated using artificial intelligence (AI) and/or machine learning (ML). In some examples, the informational content is a summary generated using AI and ML based on multiple sources. For example, information about the plant 502 includes a prose description of the classification of the plant, a native environment and/or climate of the plant, care instructions for the plant, and/or a description of the lifecycle of the plant synthesized from multiple sources and summarized using AI and/or ML. In some examples, these sources include a database, such as a dictionary, thesaurus, synonym and/or antonym list, and/or encyclopedia or other reference databased, accessed via the internet and/or stored in memory 512.

Predicting the informational content the user will request, and storing prioritized information in memory 512 prior to receiving a request to present the informational content, may enhance user interactions with the electronic device 501 by reducing the time it takes to present the informational content in response to receiving the input requesting the informational content. Examples of inputs requesting the informational content include voice inputs, attention and/or gaze inputs, gesture inputs, and/or inputs received using a hardware input device in communication with the electronic device 501. For example, the input includes attention of the user being directed to a respective object. Additionally or alternatively, as another example, the input includes detecting the user point to the respective object with a finger, including detecting a pointing finger extended towards the object optionally while the other fingers are curled in a fist. Additionally or alternatively, as another example, the input includes detecting a hand or finger touching the respective object or within a predefined threshold distance (e.g., 0.5, 1, 2, 3, 5, or 10 centimeters) of the respective object. Additionally or alternatively, as another example, the input includes detecting the pointing gesture being maintained for a predefined time period (e.g., 0.2, 0.4, 0.8, 1, 2, or 3 seconds). Additionally or alternatively, as another example, the input includes detecting that the hand does not move over a threshold speed (e.g., 1, 2, 3, 5, 10, or 30 centimeters per second) while making the pointing gesture. Optionally, one or more of these inputs are detected by capturing one or more optical captures using one or more cameras of the electronic device 501.

In response to receiving an input requesting informational content about a respective object in the physical environment of the electronic device 501, the electronic device 501 initiates a process to present the requested informational content. In some examples, in accordance with a determination that the informational content is already stored (e.g., cached) in memory 512, the electronic device 501 presents the cached informational content. In some examples, in accordance with a determination that the informational content is not already stored (e.g., cached) in memory 512, the electronic device 501 obtains the information from another source, such as one or more of the sources described previously, in response to receiving the input. For example, the electronic device 501 has not cached any information related to the respective object, or has cached other information related to the respective object, but not the requested information. In some examples, presenting information that is already cached takes less time and/or computing resources than obtaining information from another source.

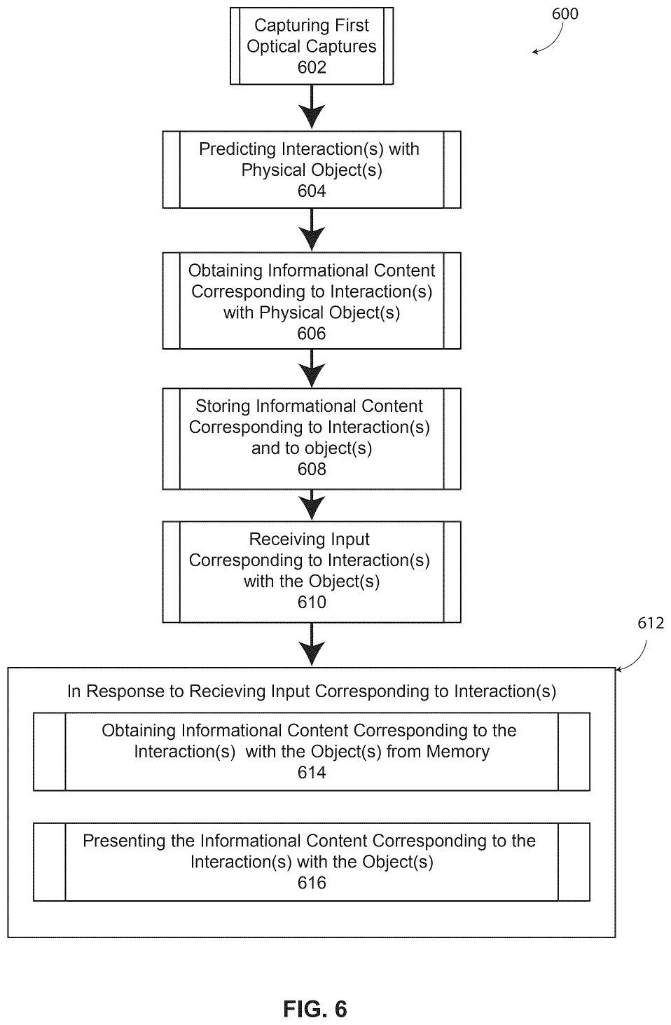

In some examples, a method 600 is performed by the electronic device, as illustrated in FIG. 6 for instance, wherein the electronic device predicts one or more potential interactions with the one or more physical objects in physical environment, and obtains informational content for purposes of caching the informational content for quick-response call-up of relevant informational content in the event the user performs the predicted one or more interactions with the one or more physical objects. In some examples, the electronic device captures, at 602, one or more optical captures (such as optical captures 514 in FIG. 5) for the purposes of performing one or more operations on the one or more first optical captures including, but not limited to: OCR, graphical content searching, and/or an AI model driven search. The one or more operations optionally share one or more characteristics with the one or more operations as described in relation to method 400. In some examples, following capturing the one or more first optical captures, the electronic device predicts, at 604, one or more interactions with one or more physical objects which are detected in the one or more first optical captures. Predicting the one or more interactions with the one or more physical objects in the physical environment optionally includes, but is not limited to: generating and/or obtaining a semantic heatmap of prior interactions within the physical environment, predicting interactions with a first physical object which corresponds to and/or is similar to a second physical objects which the user previously interacted with, predicting interactions based on location of the electronic device (e.g., detected via the one or more location sensors 204 shown in FIG. 2A-FIG. 2B), predicting the type of interaction based on frequency of certain interactions performed by the user (e.g., based on gaze, gesture, etc.), using one or more AI models to generate probabilities and/or predict interactions, etc. In some examples, the electronic device obtains, at 606, informational content corresponding to the one or more interactions with the one or more physical objects which are predicted by the electronic device. The informational content is optionally obtained and/or generated by: searching preexisting references (e.g., websites, publications, etc.), previously stored information at the electronic device and/or at a second electronic device 350 (e.g., phone in FIG. 3B) which is digitally connected and/or networked with the electronic device, and/or using one or more AI models. The informational content optionally corresponds to the one or more interactions and/or to the one or more objects to which the one or more interactions correspond to. After the electronic device obtains the informational content corresponding to the predicted one or more interactions with the one or more physical objects, the electronic device optionally stores, at 608, the informational content (e.g., via one or more memories 220A and/or 220B in FIG. 2A-FIG. 2B). In some examples, when the electronic device receives an input, at 612, which corresponds to the one or more predicted interactions with one or more physical objects, the electronic device obtains (e.g., retrieves from one or more memories 220A and/or 220B at FIG. 2A-FIG. 2B), at 614, the informational content corresponding to the performed one or more interactions and/or the one or more physical objects, and presents (e.g., displaying via the one or more display generation components 214A and/or 214B at FIG. 2A-FIG. 2B, and/or plays an audible notification via the one or more speakers 216A and/or 216B at FIG. 2A-FIG. 2B), at 616, for the user.

Therefore, according to the above, some examples of the disclosure are directed to a method, comprising at an electronic device in communication with one or more displays and/or one or more input devices including one or more optical sensors: capturing, via the one or more optical sensors, one or more first optical captures of a first object in a physical environment; in response to capturing one or more first optical captures of the first object, in accordance with detecting, in the one or more first optical captures, one or more portions of a user directed to the first object and that satisfy one or more first criteria, capturing, via the one or more optical sensors, one or more second optical captures of the first object; and in response to capturing the one or more second optical captures of the first object, in accordance with a determination that the one or more portions of the user directed to the first object satisfies one or more second criteria, the one or more second criteria including a criterion that is satisfied when the one or more portions of the user occlude a first region of the first object from a viewpoint of the electronic device in the one or more second optical captures, initiating one or more first operations on the one or more first optical captures of the first region of the first object.

The present disclosure contemplates that in some examples, the data utilized can include personal information data that uniquely identifies or can be used to contact or locate a specific person. Such personal information data can include demographic data, content consumption activity, location-based data, telephone numbers, email addresses, twitter ID's, home addresses, data or records relating to a user's health or level of fitness (e.g., vital signs measurements, medication information, exercise information), date of birth, or any other identifying or personal information. Specifically, as described herein, one aspect of the present disclosure is tracking a user's biometric data.

The present disclosure recognizes that the use of such personal information data, in the present technology, can be used to the benefit of users. For example, personal information data can be used to display suggested text that changes based on changes in a user's biometric data. For example, the suggested text is updated based on changes to the user's age, height, weight, and/or health history.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user can be notified upon initiating collection that their personal information data will be accessed and then reminded again just before personal information data is accessed by the one or more devices.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification can be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, according to the above, some examples of the disclosure are directed to a method comprising: at a first electronic device in communication with one or more input devices including one or more optical sensors and a memory: capturing one or more first optical captures of one or more first objects in a first physical environment; predicting one or more interactions with the one or more first objects in the first physical environment, wherein at least a first interaction of the one or more interactions corresponds to a request for first informational content corresponding to at least a first object of the one or more first objects; after predicting the one or more interactions with the one or more first objects in the first physical environment and prior to receiving an input corresponding to the first interaction with the first object: obtaining, at a first time, the first informational content corresponding to the first interaction and to the first object; and storing, in the memory, the first informational content corresponding to the first interaction and to the first object; after storing the first informational content, receiving the input corresponding to the first interaction with the first object; and in response to receiving the input corresponding to the first interaction with the first object, and in accordance with a determination that one or more first criteria are satisfied: obtaining, at a second time after the first time, the first informational content corresponding to the first interaction with the first object from the memory; and presenting the first informational content corresponding to the first interaction with the first object. Additionally or alternatively, in some examples, obtaining, at the first time, the first informational content corresponding to the first interaction and to the first object includes accessing the informational content corresponding to at least the first object of the one or more first objects or initiating presentation of the informational content corresponding to at least the first object of the one or more first objects. Additionally or alternatively, in some examples, initiating presentation of the informational content corresponding to the first interaction and to the first object includes communicating with one or more artificial intelligence models. Additionally or alternatively, in some examples, initiating presentation of the informational content corresponding to the first interaction and to the first object includes referencing a database including dictionary information or encyclopedic information corresponding to the first object. Additionally or alternatively, in some examples, the method further comprises, after storing the first informational content, capturing one or more second optical captures of the one or more first objects in the first physical environment; wherein the input corresponding to the first interaction with the first object includes an object-interaction gesture detected in at least one of the one or more second optical captures. Additionally or alternatively, in some examples, the one or more first criteria include a criterion that is satisfied when attention of a user of the first electronic device is directed to the first object. Additionally or alternatively, in some examples, the method further comprises receiving an input corresponding to a second interaction with a second object, different from the one or more first objects, wherein the second interaction corresponds to a request for second informational content; and in response to receiving the input corresponding to the second interaction with the second object, and in accordance with a determination that one or more second criteria are satisfied: initiating a request for the second informational content corresponding to the second interaction with the second object from a second electronic device, different from the first electronic device. Additionally or alternatively, in some examples, the method includes predicting the one or more interactions with the one or more first objects in the first physical environment includes predicting a second interaction, different from the first interaction, with the first object corresponding to a request for second informational content corresponding to the first object, and the method further comprising: after predicting the one or more interactions with the one or more first objects and prior to receiving an input corresponding to the second interaction with the first object: obtaining, at a third time, the second informational content corresponding to the second interaction and to the first object; and storing, in the memory, the second informational content corresponding to the second interaction and to the first object; after storing the second informational content, receiving the input corresponding to the second interaction with the first object; and in response to receiving the input corresponding to the second interaction with the first object, and in accordance with a determination that the one or more first criteria are satisfied: obtaining, at a fourth time, the second informational content corresponding to the second interaction with the first object from the memory; and presenting the second informational content corresponding to the second interaction with the first object. Additionally or alternatively, in some examples, predicting the one or more interactions with the one or more first objects in the first physical environment includes predicting a second interaction with a second object of the one or more first objects, different from the first object, corresponding to a request for second informational content corresponding to the second object, and the method further comprising: after predicting the one or more interactions with the one or more first objects and prior to receiving an input corresponding to the second interaction with the second object: obtaining, at a third time, the second informational content corresponding to the second interaction and to the second object; and storing, in the memory, the second informational content corresponding to the second interaction and to the second object; after storing the second informational content, receiving the input corresponding to the second interaction with the second object; and in response to receiving the input corresponding to the second interaction with the second object, and in accordance with a determination that the one or more first criteria are satisfied: obtaining, at a fourth time, the second informational content corresponding to the second interaction with the second object from the memory; and presenting the second informational content corresponding to the second interaction with the second object. Additionally or alternatively, in some examples, predicting one or more interactions with the one or more first objects in the first physical environment includes obtaining a semantic heatmap of the one or more interactions corresponding to the one or more first objects in the first physical environment. Additionally or alternatively, in some examples, obtaining a semantic heatmap of the one or more interactions corresponding to the one or more first objects in the first physical environment includes predicting one or more interactions with one or more second objects in a second physical environment corresponding to a second electronic device, wherein the one or more second objects share one or more characteristics with the one or more first objects. Additionally or alternatively, in some examples, obtaining a semantic heatmap of the one or more interactions corresponding to the one or more first objects in the first physical environment includes predicting one or more interactions with one or more second objects, different from the one or more first objects, and wherein the one or more second objects share one or more characteristics with the one or more first objects. Additionally or alternatively, in some examples, obtaining a semantic heatmap of the one or more interactions corresponding to the one or more first objects in the first physical environment includes initiating generation of at least a portion of the semantic heatmap by communicating with one or more artificial intelligence models.

Some examples of the disclosure are directed to a non-transitory computer readable storage medium storing instructions, which when executed by an electronic device including memory and one or more processors coupled to the memory cause the electronic device to perform one or more of the method described herein. Some examples of the disclosure are directed to an electronic device including memory and one or more processors coupled to the memory and configured to perform one or more of the methods described herein.

Therefore, although the present disclosure broadly covers use of personal information data to implement one or more various disclosed examples, the present disclosure also contemplates that the various examples can also be implemented without the need for accessing such personal information data. That is, the various examples of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative descriptions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at a first electronic device in communication with one or more input devices including one or more optical sensors and a memory:
capturing one or more first optical captures of one or more first objects in a first physical environment;
predicting one or more interactions with the one or more first objects in the first physical environment, wherein at least a first interaction of the one or more interactions corresponds to a request for first informational content corresponding to at least a first object of the one or more first objects;
after predicting the one or more interactions with the one or more first objects in the first physical environment and prior to receiving an input corresponding to the first interaction with the first object:
obtaining, at a first time, the first informational content corresponding to the first interaction and to the first object; and
storing, in the memory, the first informational content corresponding to the first interaction and to the first object;
after storing the first informational content, receiving the input corresponding to the first interaction with the first object; and
in response to receiving the input corresponding to the first interaction with the first object, and in accordance with a determination that one or more first criteria are satisfied:
obtaining, at a second time after the first time, the first informational content corresponding to the first interaction with the first object from the memory; and
presenting the first informational content corresponding to the first interaction with the first object.

2. The method of claim 1, wherein obtaining, at the first time, the first informational content corresponding to the first interaction and to the first object includes accessing the informational content corresponding to at least the first object of the one or more first objects or initiating presentation of the informational content corresponding to at least the first object of the one or more first objects.

3. The method of claim 1, further comprising:
after storing the first informational content, capturing one or more second optical captures of the one or more first objects in the first physical environment,
wherein the input corresponding to the first interaction with the first object includes an object-interaction gesture detected in at least one of the one or more second optical captures.

4. The method of claim 3, wherein the one or more first criteria include a criterion that is satisfied when attention of a user of the first electronic device is directed to the first object.

5. The method of claim 1, further comprising:
receiving an input corresponding to a second interaction with a second object, different from the one or more first objects, wherein the second interaction corresponds to a request for second informational content; and
in response to receiving the input corresponding to the second interaction with the second object, and in accordance with a determination that one or more second criteria are satisfied:
initiating a request for the second informational content corresponding to the second interaction with the second object from a second electronic device, different from the first electronic device.

6. The method of claim 1, wherein predicting the one or more interactions with the one or more first objects in the first physical environment includes predicting a second interaction, different from the first interaction, with the first object corresponding to a request for second informational content corresponding to the first object, and the method further comprising:
after predicting the one or more interactions with the one or more first objects and prior to receiving an input corresponding to the second interaction with the first object:
obtaining, at a third time, the second informational content corresponding to the second interaction and to the first object; and
storing, in the memory, the second informational content corresponding to the second interaction and to the first object;
after storing the second informational content, receiving the input corresponding to the second interaction with the first object; and
in response to receiving the input corresponding to the second interaction with the first object, and in accordance with a determination that the one or more first criteria are satisfied:
obtaining, at a fourth time, the second informational content corresponding to the second interaction with the first object from the memory; and
presenting the second informational content corresponding to the second interaction with the first object.

7. The method of claim 1, wherein predicting the one or more interactions with the one or more first objects in the first physical environment includes predicting a second interaction with a second object of the one or more first objects, different from the first object, corresponding to a request for second informational content corresponding to the second object, and the method further comprising:
after predicting the one or more interactions with the one or more first objects and prior to receiving an input corresponding to the second interaction with the second object:
obtaining, at a third time, the second informational content corresponding to the second interaction and to the second object; and
storing, in the memory, the second informational content corresponding to the second interaction and to the second object;
after storing the second informational content, receiving the input corresponding to the second interaction with the second object; and
in response to receiving the input corresponding to the second interaction with the second object, and in accordance with a determination that the one or more first criteria are satisfied:
obtaining, at a fourth time, the second informational content corresponding to the second interaction with the second object from the memory; and
presenting the second informational content corresponding to the second interaction with the second object.

8. The method of claim 1, wherein predicting one or more interactions with the one or more first objects in the first physical environment includes obtaining a semantic heatmap of the one or more interactions corresponding to the one or more first objects in the first physical environment.

9. A first electronic device, comprising:
one or more processors;
memory; and
one or more programs, wherein the one or more programs are stored in the memory and configured to be executed by the one or more processors, the one or more programs including instructions for:
capturing one or more first optical captures of one or more first objects in a first physical environment;
predicting one or more interactions with the one or more first objects in the first physical environment, wherein at least a first interaction of the one or more interactions corresponds to a request for first informational content corresponding to at least a first object of the one or more first objects;
after predicting the one or more interactions with the one or more first objects in the first physical environment and prior to receiving an input corresponding to the first interaction with the first object:
obtaining, at a first time, the first informational content corresponding to the first interaction and to the first object; and
storing, in the memory, the first informational content corresponding to the first interaction and to the first object;
after storing the first informational content, receiving the input corresponding to the first interaction with the first object; and
in response to receiving the input corresponding to the first interaction with the first object, and in accordance with a determination that one or more first criteria are satisfied:
obtaining, at a second time after the first time, the first informational content corresponding to the first interaction with the first object from the memory; and
presenting the first informational content corresponding to the first interaction with the first object.

10. The first electronic device of claim 9, wherein obtaining, at the first time, the first informational content corresponding to the first interaction and to the first object includes accessing the informational content corresponding to at least the first object of the one or more first objects or initiating presentation of the informational content corresponding to at least the first object of the one or more first objects.

11. The first electronic device of claim 9, wherein the one or more programs further include instructions for:
after storing the first informational content, capturing one or more second optical captures of the one or more first objects in the first physical environment,
wherein the input corresponding to the first interaction with the first object includes an object-interaction gesture detected in at least one of the one or more second optical captures.

12. The first electronic device of claim 11, wherein the one or more first criteria include a criterion that is satisfied when attention of a user of the first electronic device is directed to the first object.

13. The first electronic device of claim 9, wherein the one or more programs further include instructions for:
receiving an input corresponding to a second interaction with a second object, different from the one or more first objects, wherein the second interaction corresponds to a request for second informational content; and
in response to receiving the input corresponding to the second interaction with the second object, and in accordance with a determination that one or more second criteria are satisfied:
initiating a request for the second informational content corresponding to the second interaction with the second object from a second electronic device, different from the first electronic device.

14. The first electronic device of claim 9, wherein predicting the one or more interactions with the one or more first objects in the first physical environment includes predicting a second interaction, different from the first interaction, with the first object corresponding to a request for second informational content corresponding to the first object, and the one or more programs further including instructions for:
after predicting the one or more interactions with the one or more first objects and prior to receiving an input corresponding to the second interaction with the first object:
obtaining, at a third time, the second informational content corresponding to the second interaction and to the first object; and
storing, in the memory, the second informational content corresponding to the second interaction and to the first object;
after storing the second informational content, receiving the input corresponding to the second interaction with the first object; and
in response to receiving the input corresponding to the second interaction with the first object, and in accordance with a determination that the one or more first criteria are satisfied:
obtaining, at a fourth time, the second informational content corresponding to the second interaction with the first object from the memory; and
presenting the second informational content corresponding to the second interaction with the first object.

15. The first electronic device of claim 9, wherein predicting the one or more interactions with the one or more first objects in the first physical environment includes predicting a second interaction with a second object of the one or more first objects, different from the first object, corresponding to a request for second informational content corresponding to the second object, and the one or more programs further including instructions for:
after predicting the one or more interactions with the one or more first objects and prior to receiving an input corresponding to the second interaction with the second object:
obtaining, at a third time, the second informational content corresponding to the second interaction and to the second object; and
storing, in the memory, the second informational content corresponding to the second interaction and to the second object;
after storing the second informational content, receiving the input corresponding to the second interaction with the second object; and
in response to receiving the input corresponding to the second interaction with the second object, and in accordance with a determination that the one or more first criteria are satisfied:
obtaining, at a fourth time, the second informational content corresponding to the second interaction with the second object from the memory; and
presenting the second informational content corresponding to the second interaction with the second object.

16. The first electronic device of claim 9, wherein predicting one or more interactions with the one or more first objects in the first physical environment includes obtaining a semantic heatmap of the one or more interactions corresponding to the one or more first objects in the first physical environment.

17. A non-transitory computer readable storage medium storing one or more programs, the one or more programs comprising instructions, which when executed by one or more processors of a first electronic device, cause the first electronic device to:
capture one or more first optical captures of one or more first objects in a first physical environment;
predict one or more interactions with the one or more first objects in the first physical environment, wherein at least a first interaction of the one or more interactions corresponds to a request for first informational content corresponding to at least a first object of the one or more first objects;
after predicting the one or more interactions with the one or more first objects in the first physical environment and prior to receiving an input corresponding to the first interaction with the first object:
obtain, at a first time, the first informational content corresponding to the first interaction and to the first object; and
store, in memory, the first informational content corresponding to the first interaction and to the first object;
after storing the first informational content, receiving the input corresponding to the first interaction with the first object; and
in response to receiving the input corresponding to the first interaction with the first object, and in accordance with a determination that one or more first criteria are satisfied:
obtain, at a second time after the first time, the first informational content corresponding to the first interaction with the first object from the memory; and
present the first informational content corresponding to the first interaction with the first object.

18. The non-transitory computer readable storage medium of claim 17, wherein obtaining, at the first time, the first informational content corresponding to the first interaction and to the first object includes accessing the informational content corresponding to at least the first object of the one or more first objects or initiating presentation of the informational content corresponding to at least the first object of the one or more first objects.

19. The non-transitory computer readable storage medium of claim 17, wherein the instructions further cause the first electronic device to:
after storing the first informational content, capture one or more second optical captures of the one or more first objects in the first physical environment,
wherein the input corresponding to the first interaction with the first object includes an object-interaction gesture detected in at least one of the one or more second optical captures.

20. The non-transitory computer readable storage medium of claim 19, wherein the one or more first criteria include a criterion that is satisfied when attention of a user of the first electronic device is directed to the first object.

21. The non-transitory computer readable storage medium of claim 17, wherein the instructions further cause the first electronic device to:
receive an input corresponding to a second interaction with a second object, different from the one or more first objects, wherein the second interaction corresponds to a request for second informational content; and
in response to receiving the input corresponding to the second interaction with the second object, and in accordance with a determination that one or more second criteria are satisfied:
initiate a request for the second informational content corresponding to the second interaction with the second object from a second electronic device, different from the first electronic device.

22. The non-transitory computer readable storage medium of claim 17, wherein predicting the one or more interactions with the one or more first objects in the first physical environment includes predicting a second interaction, different from the first interaction, with the first object corresponding to a request for second informational content corresponding to the first object, and the instructions further cause the first electronic device to:
after predicting the one or more interactions with the one or more first objects and prior to receiving an input corresponding to the second interaction with the first object:
obtain, at a third time, the second informational content corresponding to the second interaction and to the first object; and
store, in the memory, the second informational content corresponding to the second interaction and to the first object;
after storing the second informational content, receiving the input corresponding to the second interaction with the first object; and
in response to receiving the input corresponding to the second interaction with the first object, and in accordance with a determination that the one or more first criteria are satisfied:
obtain, at a fourth time, the second informational content corresponding to the second interaction with the first object from the memory; and
present the second informational content corresponding to the second interaction with the first object.

23. The non-transitory computer readable storage medium of claim 17, wherein predicting the one or more interactions with the one or more first objects in the first physical environment includes predicting a second interaction with a second object of the one or more first objects, different from the first object, corresponding to a request for second informational content corresponding to the second object, and the instructions further cause the first electronic device to:
after predicting the one or more interactions with the one or more first objects and prior to receiving an input corresponding to the second interaction with the second object:
obtain, at a third time, the second informational content corresponding to the second interaction and to the second object; and
store, in the memory, the second informational content corresponding to the second interaction and to the second object;
after storing the second informational content, receiving the input corresponding to the second interaction with the second object; and
in response to receiving the input corresponding to the second interaction with the second object, and in accordance with a determination that the one or more first criteria are satisfied:
obtaining, at a fourth time, the second informational content corresponding to the second interaction with the second object from the memory; and
presenting the second informational content corresponding to the second interaction with the second object.

24. The non-transitory computer readable storage medium of claim 17, wherein predicting one or more interactions with the one or more first objects in the first physical environment includes obtaining a semantic heatmap of the one or more interactions corresponding to the one or more first objects in the first physical environment.
